(19) United States
(12) Patent Application Publication
(10) Pub. No.: US 2020/0211011 A1
(43) Pub. Date: Jul. 2, 2020

(54) Scalable Distributed Ledger System

(71) Applicant: Leverage Rock LLC, Albuquerque, NM (US)

(72) Inventor: Thomas G. Anderson, Albuquerque, NM (US)

(21) Appl. No.: 16/818,094

(22) Filed: Mar. 13, 2020

Related U.S. Application Data
(63) Continuation-in-part of application No. PCT/US2018/053242, filed on Sep. 27, 2018.
Application No. PCT/US2018/053242 is a continuation-in-part of application No. PCT/US2018/053240, filed on Sep. 27, 2018.
Application No. PCT/US2018/053240 is a continuation-in-part of application No. PCT/US2018/053243, filed on Sep. 27, 2018.
(60) Provisional application No. 62/565,099, filed on Sep. 29, 2017.
(60) Provisional application No. 62/571,556, filed on Oct. 12, 2017.
(60) Provisional application No. 62/585,943, filed on Nov. 14, 2017.
(60) Provisional application No. 62/644,841, filed on Mar. 19, 2018.
(60) Provisional application No. 62/565,099, filed on Sep. 29, 2017.
(60) Provisional application No. 62/571,556, filed on Oct. 12, 2017.
(60) Provisional application No. 62/585,943, filed on Nov. 14, 2017.
(60) Provisional application No. 62/644,841, filed on Mar. 19, 2018.
(60) Provisional application No. 62/565,099, filed on Sep. 29, 2017.
(60) Provisional application No. 62/571,556, filed on Oct. 12, 2017.
(60) Provisional application No. 62/585,943, filed on Nov. 14, 2017.
(60) Provisional application No. 62/644,841, filed on Mar. 19, 2018.

(51) Int. Cl. G06Q 20/40; G06Q 20/36; G06Q 20/06; G06F 16/27; H04L 9/06

(52) U.S. Cl. CPC G06Q 20/401; G06Q 20/3674; G06Q 20/0655; H04L 2209/56; H04L 9/0643; H04L 2209/38; G06F 16/27

(57) ABSTRACT

Some embodiments of the present invention provide a method of recording transactions using a T1 distributed ledger in a distributed database over a first distributed network of computers, and a plurality of T2 distributed ledgers each in a distributed database over a corresponding distributed network of computers, wherein each T2 distributed ledger has associated with it a corresponding plurality of wallets that are not also associated with any other T2 distributed ledger, comprising: (a) recording transactions identifying an originating wallet in the T2 distributed ledger associated with the originating wallet; (b) for any transactions that identify a recipient wallet that is not associated with the same T2 distributed ledger as the originating wallet, after recording the transaction in the associated T2 distributed ledger then recording the transaction in the T1 distributed ledger, and then recording the transaction in the T2 distributed ledger associated with the recipient wallet.

### CROSSREFERENCE TO RELATED APPLICATIONS

This application claims priority as a continuation in part of PCT applications PCT/US2018/053240, filed 27 Sep. 2018; PCT/US2018/053242, filed 27 Sep. 2018; and PCT/US2018/053243, filed 27 Sep. 2018; and to the following US provisional applications to which the preceding claimed priority: 62/565,099 filed Sep. 29, 2017, 62/571,556 filed Oct. 12, 2017, 62/585,943 filed Nov. 14, 2017, and 62/644,841 filed Mar. 19, 2018. Each of the foregoing is incorporated herein by reference.

### TECHNICAL FIELD

The present invention is related to the field of cryptocurrency and distributed ledgers such as blockchains.

### BACKGROUND ART

A cryptocurrency is a digital system used to implement and track financial transactions. Bitcoin is a widely known example of a cryptocurrency. Bitcoin uses decentralized control and blockchains to implement a distributed ledger. As of September 2017, over 1,000 cryptocurrency specifications exist. Many of them share various shortcomings that have surfaced as bitcoin has spread. Some of the shortcomings are summarized below.

Governance. Many cryptocurrencies have a governance model that is set at creation, and cannot be modified later due to the distributed nature of the system. This can prevent a cryptocurrency from adapting to new laws, regulations, or user needs.

Scalability. Many cryptocurrencies suffer from a limit on the rate at which transactions can be processed.

Time and energy requirements for mining. The proof-of-work model behind Bitcoin requires significant computing power, to the extent that the electrical power for bitcoin miners exceeds the energy usage of many small countries.

Expense of mining. New coin issuances in Bitcoin go to the miners themselves, currently about $9million per day. The dollar amount available, plus the huge compute power requirements, lead to unexpected economic decisions where the price of electricity determines the mining effort, and the mining resources become increasingly concentrated in a decreasing number of high capacity miners.

There are various trustless blockchains in existence that can be used to implement cryptocurrencies and other such concepts. The assumptions behind such blockchains, specifically the assumption that there is no trusted entity, limit such blockchains from providing immediate transactions, privacy protections, a stable cryptocurrency, and the prevention of fraud, theft, and loss. Some embodiments of the present invention provide mechanisms that can be used with existing blockchains to facilitate such desirable features.

### SUMMARY OF INVENTION

The description at times refers to aspects as “essential” or “most important” or “must include” or similar; those references are intended to highlight aspects for the reader's attention, and do not mean that the invention is limited to embodiments that include those aspects. The description also describes one or more example embodiments. Various alternative embodiments are contemplated, including example embodiments in which parameters described as varying can be set, or varied upon different events or timing; and in which parameters described as fixed in some example embodiments can be varied.

Example embodiments of the present invention provide a method of recording transactions using a distributed database over a first distributed network of computers, a second distributed network of computers, and a third distributed network of computers, comprising: (a) recording a second set of transactions in a second distributed ledger (where “distributed ledger” includes blockchains and other distributed ledger technologies) maintained by the second distributed network of computers (where “maintained” includes operations required for operation of the distributed ledger, such as consensus on block addition, authorization to record transactions, and other operations and communications useful in making the distributed ledger operate); (b) recording a third set of transactions in a third distributed ledger maintained by the third distributed network of computers; (c) recording entries that correspond to transactions in blocks in the second and third distributed ledgers in a first distributed ledger maintained by the first distributed network of computers; (where “entries” can be transactions signed by users, can be subsets or combinations of such transactions, e.g., transactions consolidated or grouped, or transactions without information such as sender or sender signature, or transactions with the receiver identified and the originator omitted and signed by sending distributed ledger); (d) recording entries that correspond to blocks in the first distributed ledger in the second and third distributed ledgers.

In some embodiments, the first, second, and third networks have at least some computers that are located at physically different sites.

In some embodiments, the first distributed network of computers comprises computers connected with low latency connections.

In some embodiments, the first distributed network of computers comprises computers located within 50 miles of each other.

In some embodiments, the second distributed ledger has associated with it a second plurality of wallets (where a “wallet” is anything that is associated with or owned or controlled by a user and can be used to group and track assets, such as an account or a digital receptacle for assets); and wherein transactions that are between wallets in the second plurality are recorded on the second distributed ledger and not recorded on the first distributed ledger.

In some embodiments, the second distributed ledger has associated with it a second plurality of wallets, and transactions that remove an asset from a wallet in the second plurality and assign the asset to a wallet not in the second plurality are recorded on the second distributed ledger, and then recorded on the first distributed ledger.

In some embodiments, the second distributed ledger has associated with it a second plurality of wallets, and transactions that remove an asset from a wallet not in the second plurality and assign the asset to a wallet in the second plurality are recorded on the first blockchain, and then recorded on the second distributed ledger.

In some embodiments, the second distributed ledger has associated with it a second plurality of wallets, and the third distributed ledger has associated with it a third plurality of wallets, and wherein transactions that remove an asset from a wallet in the second plurality and assign the asset to a wallet in the third plurality are recorded on the second distributed ledger, and then recorded on the first distributed ledger, and then recorded on the third distributed ledger.

In some embodiments, the second distributed ledger has associated with it a second plurality of wallets, and the third distributed ledger has associated with it a third plurality of wallets, and the first and second plurality of wallets are distinct.

In some embodiments, there is no wallet that is in both the second and third pluralities of wallets.

In some embodiments, the method further comprises associating with each wallet an indication of whether the wallet is in the second or third plurality.

In some embodiments, the wallet/distributed ledger association is maintained in a database, and wherein the indication can be changed in the database.

In some embodiments, step (c) comprises determining a consolidated representation of transactions in one or more blocks in the second distributed ledger and recording that consolidated representation in the first distributed ledger.

In some embodiments, the consolidated representation is authenticated as a valid block in the second distributed ledger and cryptographically secured before recording on the first distributed ledger.

In some embodiments, step (d) comprises determining one or more transactions in the first distributed ledger to record on the second distributed ledger, and then recording those transactions on the second distributed ledger.

In some embodiments, the second distributed ledger has associated with it a plurality of wallets, and wherein the transactions determined to record on the second distributed ledger comprise transactions with a recipient wallet associated with the second distributed ledger.

In some embodiments, step (c) comprises arranging a second entry such that transactions to later be recorded on the second distributed ledger are grouped in the recording of the second entry on the first distributed ledger.

In some embodiments, step (c) comprises arranging a third entry such that transactions to later be recorded on the third distributed ledger are grouped in the recording of the third entry on the first distributed ledger.

In some embodiments, a transaction showing the asset transferring out of the wallet cannot be recorded on the second distributed ledger unless a transaction showing the asset transferring into the wallet has previously been recorded on the second distributed ledger.

In some embodiments, the first distributed ledger has recorded on it sufficient information to determine all the asset transfers recorded on the second and third distributed ledgers.

Some embodiments of the present invention provide a method of recording transactions on a first distributed ledger implemented on a distributed database using a distributed network of computers, wherein the first distributed ledger has a plurality of wallets associated with it, comprising: (a) determining if a candidate transaction originates from a wallet that is associated (where “associated” means defined as assigned to this distributed ledger, and that the associated distributed ledger controls the authoritative determination of assets in the wallet) with the first distributed ledger, and, if so, recording the transaction on the first distributed ledger (where “originates from” means that the asset being transferred or otherwise affected in the transaction is controlled by the wallet, which authority is often authenticated by public/private key encryption); (b) determining if a candidate transaction indicates an asset transfer from an originating wallet that is associated with a second distributed ledger to a recipient wallet that is associated with the first distributed ledger, and if the candidate transaction is authenticated by an authenticating entity associated with the second distributed ledger, then recording the transaction on the first distributed ledger (where “authenticated” includes various ways of authentication, including cryptographic signing, inclusion of information that ensure authentication, and zero knowledge proofs).

In some embodiments, the authenticating entity is not the owner of the wallet.

In some embodiments, the authenticating entity authenticates a transaction if the owner of the wallet has authenticated the transaction.

In some embodiments, the authenticating entity authenticates a transaction if the originating wallet is verified to have rights to transfer the asset.

Some embodiments of the present invention provide a method of recording transactions using a T1 distributed ledger in a distributed database over a first distributed network of computers, and a plurality of T2 distributed ledgers each in a distributed database over a corresponding distributed network of computers, wherein each T2 distributed ledger has associated with it a corresponding plurality of wallets that are not also associated with any other T2 distributed ledger, comprising: (a) recording transactions identifying an originating wallet in the T2 distributed ledger associated with the originating wallet; (b) for any transactions that identify a recipient wallet that is not associated with the same T2 distributed ledger as the originating wallet, after recording the transaction in the associated T2 distributed ledger then recording the transaction in the T1 distributed ledger, and then recording the transaction in the T2 distributed ledger associated with the recipient wallet.

In some embodiments, recording the transaction in the T1 distributed ledger comprises recording a subset of the transaction, which subset includes the asset (where an “asset” can include indicia of ownership of physical assets as well as varying amounts or balances of a cryptocurrency) and the recipient wallet.

In some embodiments, recording the transaction in the T1 distributed ledger comprises recording the transaction in a data structure ordered according to the T2 distributed ledgers associated with the recipient wallet in each transaction.

In some embodiments, recording the transaction in the T1 distributed ledger comprises waiting until the recording of the transaction in the T2 distributed ledger is immutable, then recording the transaction in the T1 distributed ledger.

In some embodiments, recording the transaction in the T2 distributed ledger associated with the recipient wallet comprises waiting until the recording of the transaction in the T1 distributed ledger is immutable, then recording the transaction in the T2 distributed ledger.

Some embodiments of the present invention provide a method of managing digital assets using a plurality of distributed ledgers implemented in distributed databases over distributed networks of computers, comprising establishing a wallet; establishing an association of the wallet with a first network of the plurality of networks such that transactions with assets leaving the wallet are first recorded on the first network's distributed ledger; then removing the association of the wallet with the first network and establishing an association of the wallet with a second network of the plurality of networks such that transactions with assets leaving the wallet are first recorded on the second distributed ledger.

Some embodiments of the present invention provide a method of managing digital assets, comprising establishing a wallet associated with a first distributed ledger, wherein transfers of digital assets into the wallet are recorded on the first distributed ledger, and transfers of digital assets out of the wallet are recorded on the first distributed ledger, wherein at least some transfers of digital assets into the wallet are recorded on a second distributed ledger before being recorded on the first distributed ledger.

Some embodiments further comprise a plurality of wallets each associated with one of a plurality of distributed ledgers, and recording transactions on the distributed ledger associated with the originating wallet of a transaction, and recording transactions on the distributed ledger associated with the owner of the recipient wallet after the transaction is recorded on the distributed ledger associated with the owner of the originating wallet.

In some embodiments, recording transactions on the distributed ledger associated with the owner of the recipient wallet if the transaction either (a) has an originating wallet associated with the distributed ledger and is authenticated by the owner of the wallet, or (b) has an originating wallet associated with another distributed ledger and is authenticated by such other distributed ledger.

In some embodiments, transactions that remove an asset from (where “remove an asset” includes removing or canceling an indicia of ownership of a physical asset or fiat currency, or removing all or part of a balance of cryptocurrency) a wallet can only be recorded on the distributed ledger associated with that wallet.

Some embodiments of the present invention provide a system for maintaining a distributed ledger of transactions, comprising: (a) a first plurality of computers connected over a distributed network implementing a T1 distributed ledger as described above; (b) a second plurality of computers connected over a distributed network implementing a first T2 distributed ledger as described above; (c) a third plurality of computers connected over a distributed network implementing a second T2 distributed ledger as described above; (d) wherein at least some of the computers in the first plurality of computers are not in the second or third plurality of computers.

Some trademarks are used in the description to refer to products and services provided by others, such as ERC20, Ethereum, and Ripple. The owners of such marks reserve all rights in such marks.

Some embodiments of the present invention provide a method of implementing a private but traceable primary transaction implementing a transfer of an asset from an originator to a recipient using a third party, using a distributed network of computers implementing a distributed ledger (where a “distributed ledger” includes hashgraphs, blockchains, and the like), comprising: (a) recording at the third party information relative to the originator that allows determination of the identity of the originator (where “identity” can be direct identifying information such as name, address, government identification number; or identification of a wallet that can be connected to a particular user, or a mechanism such as a zero knowledge proof that allows identity to be established later) (where “recording at the third party” means storing on persistent memory such that can be recalled later if needed, e.g., ROM, Flash memory, optical disks, magnetic disks, or others); (b) recording on the distributed ledger a transfer of the asset from the originator to the third party and verifying that said transfer has been recorded on the distributed ledger (where “recording on the distributed ledger” can comprise various mechanisms, depending on the specific implementation used, and in general involves submitting the transaction to the network of computers implementing the distributed ledger, with cryptographical authentication of the transaction, and observing the distributed ledger until the transaction is on a block known to be immutable, and where “transfer of the asset” can be just the asset needed for the primary transaction or can include that asset and other assets e.g. large sum of money of which a subset is used for the primary transaction and rest remains with third party for satisfying other transaction requests); (c) communicating from the originator to the third party an identifier of the recipient, where said communication is not recorded on the distributed ledger (if the third party holds only a single, indivisible asset of the originator, then the request from the originator only needs to specify the recipient; but if the recipient holds more than one asset, or a divisible asset such as currency, then the request from the originator can also specify the particular asset of subset of asset to be transferred); (d) defining a plurality of secondary transactions, each comprising the recipient and a secondary originating party and an asset portion, wherein the combination of asset portions corresponds to the asset (where “corresponds to the asset” means that the combination of asset portions satisfies the requirements for the transfer of the asset; with a simple currency transfer the correspondence can simply be that the sum of the portions equals the requested amounts; in some situations the correspondence can be other than a simple sum, e.g., to cover transaction fees, recording fees, conversion fees, discounts, holdbacks, etc.) and at least some of which secondary originating parties indicate a party other than the originator; (e) recording on the distributed ledger the plurality of secondary transactions.

In some embodiments, the number of the plurality of secondary transactions is determined by a predetermined method (where a “predetermined method” can include selecting a random number, or selecting a number by an algorithmic method, e.g., responsive to factors such as the size of value of the asset, the identity or location of the originator, the identity or location of the recipient, the identity of the third party, the time of the transfer, a history of transactions of the recipient, a history of transactions of the originator) at least equal to a predetermined lower bound. In general, more secondary transactions can make it harder to reconstruct the primary transaction, e.g., splitting a primary transaction into 2 secondary transactions somewhat obscures the primary transaction; splitting into 5 obscures it more, into 10 or 100 even more. More secondary transactions means more overhead in submitting and recording the transactions, however.

In some embodiments, the number of the plurality of secondary transactions is a random number no more than a predetermined upper bound. An upper bound on the number of secondary transactions can reduce overhead, e.g., if there is a recording fee for each secondary transaction then the recording fees can become prohibitive if the number of secondary transactions is too high relative to the size of the primary transaction.

In some embodiments, the third party controls a plurality of wallets on the distributed ledger, and where at least one of the plurality of secondary originating parties is associated with a different wallet than at least one other of the plurality of secondary originating parties.

In some embodiments, recording the plurality of secondary transactions comprises recording the plurality of secondary transactions at a plurality of times. The secondary transaction recording can be spread over a few minutes, a few days, or even longer depending on the nature and size of the primary transaction, and the desire for urgency balanced against the desire to keep the transaction private.

In some embodiments, at least two of the plurality of times are separated by a time interval determined by a predetermined method and no less than a predetermined lower bound. More separation can make it harder to reconstruct the primary transaction, so separations of at least one minute, 30 minutes, one day, or longer can be useful in some situations.

In some embodiments, at least two of the plurality of times are separated by a time interval determined by a predetermined method and no more than a predetermined upper bound. An upper bound can help the parties know when the primary transaction will be complete by recording of all the secondary transactions, and can be selected to ensure that the need for urgency is satisfied while allowing enough time for other transactions to obscure the relationship of the secondary transactions to each other.

In some embodiments, the third party receives communications specifying a plurality of primary transactions, at least one of which is from the originator and at least one of which is from a party other than the originator, and all of which are to the recipient, and wherein the third party combines the plurality of primary transactions to the recipient and the combined transaction is treated as the primary transaction for the remainder of the method.

In some embodiments, the number of the plurality of secondary transactions is determined by a predetermined method and at least equal to a predetermined lower bound.

In some embodiments, the number of the plurality of secondary transactions is determined by a predetermined method and no more than a predetermined upper bound.

In some embodiments, the third party controls a plurality of wallets on the distributed ledger, and where at least one of the plurality of secondary originating parties is associated with a different wallet than at least one other of the plurality of secondary originating parties.

In some embodiments, recording the plurality of secondary transactions comprises recording the plurality of secondary transactions at a plurality of times.

In some embodiments, at least two of the plurality of times are separated by a time interval determined by a predetermined method and no less than a predetermined lower bound.

In some embodiments, at least two of the plurality of times are separated by a time interval determined by a predetermined method and no more than a predetermined upper bound.

In some embodiments, the originator and the recipient are the same entity. This can be useful, as an example, to obscure ownership of assets after the owner of a wallet has been identified (e.g., by mining transactions for patterns that allow identification of an owner of a wallet). The owner can initiate a primary transaction that transfers assets out of the compromised wallet to another wallet owned by the same person, and the claimed method can make it difficult for other parties to determine the new wallet owned that now has the assets.

Some embodiments of the present invention provide a method of implementing a private but traceable transaction, from an originator to a recipient using a third party, using a distributed network of computers implementing a distributed ledger, comprising: (b) recording on the distributed ledger a transfer of an asset that requires authentication by the originator and authentication by a third party (e.g., cosigner or guarantor, adult approving child transactions, government or regulatory approval, etc.); (c) communicating from the originator to the third party verification information that verifies the originator's control of the asset; (d) verifying at the third party said verification information; (e) recording on the distributed ledger an approval of the transfer.

In some embodiments, the transfer recorded on the distributed ledger is voided if the approval is not recorded within a predetermined time.

In some embodiments, the originator can void the transfer recorded on the distributed ledger before the approval is recorded on the distributed ledger

Some embodiments of the present invention provide a method of recording on a distributed ledger implementing a distributed database on a network of computers a first transaction from an originator to a recipient, and a second transaction from the recipient to the originator, comprising: (a) recording on the distributed ledger the first transaction, including an indicator of a closing condition for the first transaction (where a “closing condition” can comprise, as examples passage of time, an externally verified event, a third party's authenticated approval such as for co-signing a transaction or regulatory approvals); (b) before the closing condition occurs, recording on the distributed ledger a second transaction from the recipient to the originator that is at least partly an inverse of the first transaction without requiring cryptographic authentication from the recipient. On conventional distributed ledgers, transfers out of a wallet require authentication by the wallet owner, but in this method a reversal that transfers out of a wallet can be authenticated by a party not the wallet owner provided the closing condition has not occurred. An inverse transaction can be a full inverse, as in the case of a complete refund, or a partial inverse, as in the case of a partial refund or discount. The details of the recording can depend on the nature of the distributed ledger, e.g., if the transactions are immutable then they can both be recorded on the distributed ledger, but if the first transaction is not immutable then the inverse transaction can remove the first transaction from the distributed ledger such that neither transaction remains on the distributed ledger.

In some embodiments, the second transaction cannot be recorded on the distributed ledger unless it is cryptographically authenticated by a third party identified in the distributed ledger as authorized to record the second transaction.

In some embodiments, the second transaction can be recorded on the distributed ledger if cryptographically authenticated by the originator.

In some embodiments, the closing condition is the passage of a predetermined time.

In some embodiments, the closing condition is approval of a reviewing party.

In some embodiments, the first transaction includes an identification of a third party who is authorized to record on the distributed ledger an inverse transaction.

In some embodiments, the first transaction cannot be recorded on the distributed ledger unless the originator is identified on the distributed ledger as authorized to initiate transactions with closing conditions.

In some embodiments, the first transaction is recorded on the distributed ledger with a closing condition if the originator is identified on the distributed ledger as always required to initiate a transaction with closing conditions on the distributed ledger.

In some embodiments, the originator is defined by information on the distributed ledger as authorized to initiate a transaction with closing conditions on the distributed ledger.

Some embodiments of the present invention provide a method of allowing a plurality of controls of a wallet in a distributed ledger implemented in a distributed database by a network of computers, comprising: (a) identifying, in an entry recorded on the distributed ledger, the wallet as having control features, wherein the wallet is controlled by a first party having a first private key; (b) recording on the distributed ledger one or more transfer transactions that transfer assets from the first wallet, which transfer transactions are authenticated by a second party with a permission mechanism, and identifying on the distributed ledger any such transfer as subject to reversal; (c) recording on the distributed ledger a reversal transaction reversing a transfer transaction, which transaction is authenticated by the first private key and is submitted to the distributed ledger within a predetermined time of the recording of such transfer transaction. A “reversal transaction” can depend on the details of the distributed ledger, e.g., it can be a second transaction that transfers an asset back from the original recipient to the original originator; it can be a second transaction that indicates the original transaction should be ignored; it can be an action that removes the original transaction from the distributed ledger if the first transaction is not immutable on the distributed ledger.

In some embodiments, the permission mechanism comprises a second private key, associated with the second party.

In some embodiments, the reversal transaction transfers assets to a wallet that is identified on the distributed ledger as not allowing transfer transactions authenticated by the second party.

Some embodiments of the present invention provide a method of providing consumer protection with transactions recorded on a distributed ledger implemented as a distributed database using a network of computers, comprising: (a) associating with a consumer wallet on the distributed ledger an indicator that the wallet is protected; (b) recording on the distributed ledger transactions out of the consumer wallet only if cryptographically authenticated by the consumer; (c) recording on the distributed ledger reversal transactions reversing previously recorded transactions out of the consumer wallet only if cryptographically authenticated by a second party.

In some embodiments, reversal transactions are recorded on the distributed ledger only if authenticated by the second party and only if the originating wallet had a protection indicator associated with it when the original transaction was recorded.

In some embodiments, the second party is identified to the consumer and to the recipient of the transaction out of the consumer wallet.

In some embodiments, a reversal transaction is an inverse of the transaction to be reversed.

In some embodiments, a reversal transaction is not recorded on the distributed ledger if it is submitted more than a predetermined time after the transaction to be reversed.

In some embodiments, a reversal transaction is not recorded unless it satisfies conditions defined in the transaction to be reversed.

### BRIEF DESCRIPTION OF DRAWINGS

FIG. 1 is a schematic illustration of a simple blockchain.

FIG. 2 is a schematic illustration of a blockchain using block-pairs.

FIG. 3 is a schematic illustration of the submission of candidate blocks.

FIG. 4 is a schematic illustration of the steps to run a Newcoin network.

FIG. 5 is a schematic illustration of a multi-tiered blockchain.

FIG. 6 is a schematic illustration of transaction methodology in a multi-tier blockchain.

FIGS. 7-15 provide a a schematic illustration of recording and validating a transaction in an example embodiment.

FIG. 16 is an illustration of an example immediate note network according to the present invention.

### INDUSTRIAL APPLICABILITY AND MODES OF CARRYING OUT THE INVENTION

Embodiments of the present invention provide a scalable architecture with easy to use oracles for creating custom blockchain solutions. Oracles can be composed into a Directed Acyclic Graph (DAG) to easily produce a use-case specific implementation. Embodiments of the present invention use a consensus mechanism called Proof-of-Validation which enables massive scaling and high performance via multi-tier sharding.

Embodiments of the present invention provide an open source blockchain protocol, which is envisioned for general-purpose use in transferring value and ownership. The cryptocurrency enabled by the present invention can be a pure cryptocurrency of limited supply. It can be fractionally divisible and expected to be long-term non-inflationary. Units of such cryptocurrency are fungible and transferable. An example protocol includes an API through which third-party developers can implement their own blockchain solutions.

Implementation Example

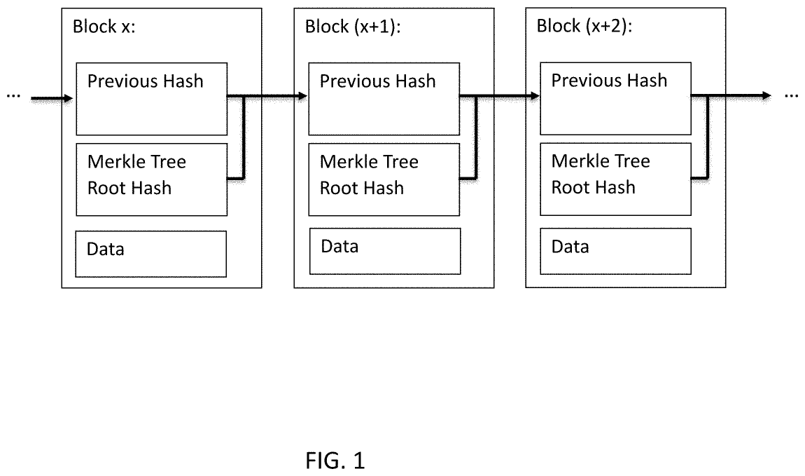

An example distributed ledger, described herein as a blockchain, embraces many of the original principles of Bitcoin, such as its desire to have payments based on cryptographic proof instead of trust, and to allow any two willing parties to financially transact directly with each other without the need for a trusted third party. As with other blockchains, ownership in the example system is fundamentally recorded and verified by a chain of digital transactions maintained by nodes on a network. Ownership is represented through wallets, which maintain a public key visible to the network where nodes can determine a currency balance, and a private key associated with that public key. All transfers of ownership, called transactions, are stored in collections of transactions, called blocks. The transactions recorded in the blocks contain the digital signatures with which transactions can be verified, which in turn verify currency ownership based on previous transactions. The ongoing cumulative addition of blocks, each referenced to the previous block, is called a blockchain. The blockchain, in its entirety, comprises a ledger that tracks all transactions and therefore all transfers of ownership. The summary of all transfers of ownership can be used to determine current currency ownership. The linear sequence of blocks in the blockchain defines a time-ordered sequence of ownership, preventing double spending. The blockchain is immutable, and currency transactions cannot be reversed. An example blockchain is shown in FIG. 1.

When any amount of currency (or other asset managed by a wallet) is transferred by a sender (also called an originator), that transaction is broadcast by the sender to the network. The transaction includes a message that describes the amount of currency (or other asset) being transferred and the sender's and recipient's public addresses. The transaction also includes a signature from the sender which is used to validate the transaction. The signature is a hash of the message encrypted with the sender's private key. Nodes on the network can use the sender's public key to decrypt and verify the transaction. Anyone has access to the public keys and can therefore verify all transactions in the blockchain.

In order to create valid blocks and prevent double spending from the publicly announced transactions, there must be a single historic sequence of valid blocks in the blockchain upon which all network nodes can agree. Blocks create a hash from the previous block's hash plus the current block's transactions (which can be represented with a root hash from a Merkle Tree implementation), thereby creating a blockchain where all blocks reference all previous blocks. However, maintaining consensus of a consistent history generally is a difficult problem. Many blockchains utilize a Proof-of-Work approach, in which miners (i.e. nodes) solve a difficult computational problem, in order to create valid blocks, get rewards, and maintain consensus. The example system, in contrast, uses a Proof-of-Validation algorithm where Validators maintain consensus.

Consensus—Proof of Validation

The example system's approach to maintaining a consensus among nodes takes the form of a permissioned public distributed ledger. The blockchain and its operations are transparent and public, and there is no central authority involved with transfers or validation itself. This approach maintains the benefits of other blockchains such as fast and easy worldwide transfers, prevention of double spending, security without compromising the blockchain's immutability, trustless transactions, lack of a central authority overseeing transactions, and resistance to collusion.

The permissioning only refers to consensus provider nodes, called Validators. These Validators can be chosen by a governing entity or organization, e.g., a trust-based company overseeing the operations of the blockchain (referred to herein as “GOV”). Through the use of public keys, validation messages can be verified. GOV can utilizes an Immediate Node Network (INN) to implement its blockchain interactions. GOV can add or remove Validators as needed to assure reliable consensus operation. Validators are simply tasked with maintaining consensus.

The Proof-of-Validation approach addresses three of the largest weaknesses in many blockchain protocols. First, the Proof-of-Work methodology wastes enormous amounts of energy, given the processing required to search for solutions to the Proof-of-Work hashing problems. Second, in many blockchains miners are paid too much and those issuances not only don't go to the community, but they create a constant downward pull on the cryptocurrency's value and increase overall DApp costs. Third, and perhaps most importantly, miners often exert too much influence on governance. Given that for most blockchains anyone can be a miner, it is often difficult to govern growth. As an example, miners often have a conflict of interest. Their short-term interests can differ from the long-term interests of the blockchain as a whole. Also, different stakeholders can disagree on the right approach for long-term growth. The example Proof-of-Validation approach does not require large amounts of computational energy, has issuances that go to its community, and allows more structured growth for the currency over time to address challenges in scaling and regulation.

The Proof-of-Validation approach does not forfeit the most important aspects of trustless transactions. Validators are paid to provide consistent consensus of the blockchain, and all transactions must still be validated with public-private key pairs and be recorded in a publicly available and immutable blockchain. Anyone can read the blockchain, and anyone can post transactions. Anyone can see the open source software used by Validators, and anyone can audit the entire system. Anyone can verify that a transaction they are involved with is valid. The Proof-of-Validation approach offers a real-world solution to the disadvantages in other blockchain approaches while maintaining the benefits of a trustless system.

Proof-of-Validation

The Proof-of-Validation approach maintains a list of all active Validators in the blockchain. Validators control nodes which implement validation and consensus, and maintain a validated state based on the full blockchain record. This approach uses system parameters that can change over time, set by Devvio, in order to adjust the methodology with respect to network conditions and potential attacks.

Activation Blocks and Validator Order

Periodically Validators announce that they are active by generating a valid activation transaction to the chain. The block at which miner activity is announced is determined privately, independently, and non-interactively by the miners based on the block height and the following parameters:

activationRounds—a parameter that determines how many rounds occur between activation blocks. A round is a number of blocks equal to the number of active Validators.

proposalTimeout—a timeout period for block proposals, if a proposal does not arrive within this timeframe, the next backup Validators should broadcast their proposal.

validationPercent—the proportion of validations needed for a final block (51% by default)

Below is an example algorithm for activation blocks and determining Validator order:

Step 1. Each Validator broadcasts an activation transaction that includes information such as its name, network address, and clock time, before the activation block is proposed. The final Validator (Vf) from the last ordering proposes this block. Any Validator that fails to send an activation transaction to Vf is presumed to be offline. If Vf times out by exceeding proposalTimeout, the order wraps around and the first 2 Validators in the previous order propose blocks. In the case of the genesis block, the initial Validator is designated in the configuration.

Step 2. Each Validator concatenates the network address for every Validator with the previous block's Merkle root and the current block height. Then, they independently calculate the SHA-256 hash of this string. In the case of the genesis block, the string is just the addresses with a 0 suffix appended for the block height. There is no previous Merkle root.

Step 3. Each Validator orders these hashes lexicographically to get a Validator order.

Step 4. Whichever Validator is first in the order should propose the next block immediately. If proposalTimeout passes and no block has been received by a Validator, double the number of Validators in the order (i.e. the next two Validators) should propose blocks. This process continues until a proposed block is received, so if the timeout passes twice, the 4th-7th Validators should all propose. Additional Validators proposing blocks will not affect the Validator ordering for future blocks.

Step 5. Validators work on all proposed blocks that they have received in parallel by validating and sending validations back to the proposer. Once any proposer has reached the validationPercent, it broadcasts the final block (which includes transactions and validations) and all Validators should move on to the next block. If two or more blocks finalize, the one proposed by the Validator closest to the starting Validator for this block is chosen.

Step 6. After a block is finalized, the next Validator in the order should immediately propose a block. The ordering is ‘round robin’, so each Validator should propose once in each round. The lead Validator for any block can easily be verified based on the activation block.

Step 7. When the order comes to the final Validator, if activationRounds==1, a new activation block is built. If activationRounds>1, every miner hashes the ordering strings (itself a hash), sorts them again to provide a new order with a uniform distribution, and decrements the number of rounds remaining before the next activation block. This happens for as many activationRounds as are specified for this network, so if activationRounds>=5 the ordering of the 5th round will be based on 5 hashes of the activation data.

One should note that this process is deterministic and non-interactive based on the activation block. During normal operations, a single Validator will propose the next block as fast as it can once the previous final block has been announced. If a new block is not proposed before proposalTimeout elapses, two more miners will also propose. This process continues with 4 more miners if the timeout elapses a second time, but any elapsed proposalTimeout raises alarms since it implies that the system is overloaded or facing a denial of service attack.

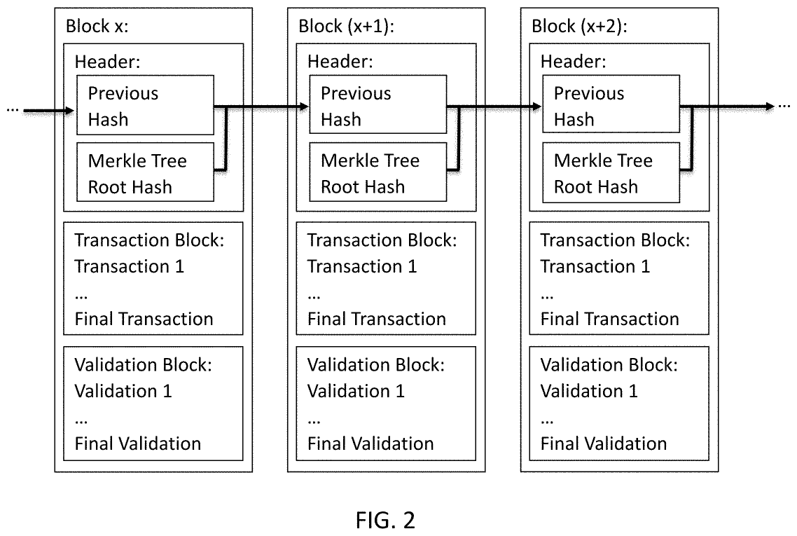

Upon receiving a proposed block, Validators simply validate this block in parallel by checking the validity of transactions, including their balances and signatures, and then updating its internal chain state. If a proposed block is valid, then Validators broadcast messages indicating their validation, which are collectively added to the block to prove validation as described below. FIG. 2 is an illustration of a blockchain with block-pairs.

When proposing candidate blocks, each Validator's candidate block consists of two components: a transaction component and a validation component, called a block-pair. The transaction component includes any valid transactions it has that are not already part of the blockchain. A transaction component can be created up to a maximum size, Bt. A transaction component is final once it is proposed, and it cannot be modified by other Validators. The validation component is finalized by the proposing Validator after receiving at least validationPercent validation messages.

After a Validator sends a proposal, it collects Validation messages from other Validators for the validation component. During this time, a Validator may also send a validation message to a proposal from any Validator higher in the order than itself, in the case where a proposer was slow or network latency was higher than usual.

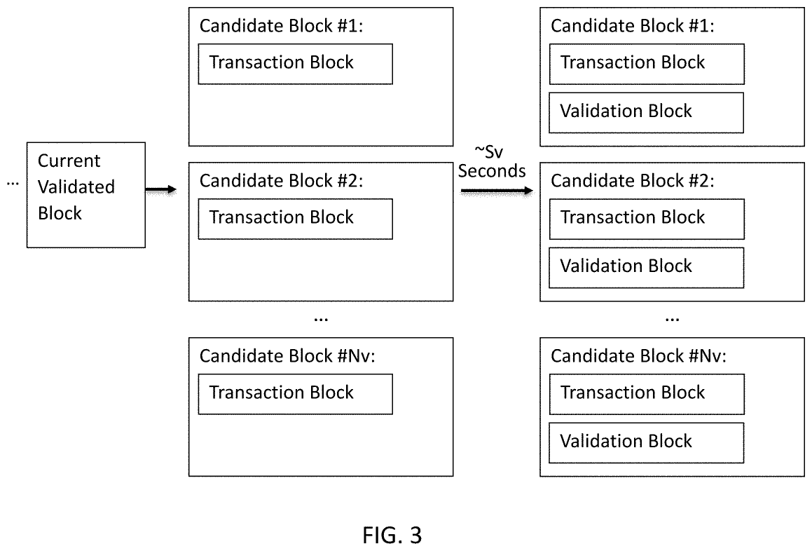

Once a proposer receives at least validationPercent Validator signatures, it creates the block header and announces the new block. Other Validators express acceptance of this block by immediately working on the next block. FIG. 3 is an illustration of the submission of candidate blocks.

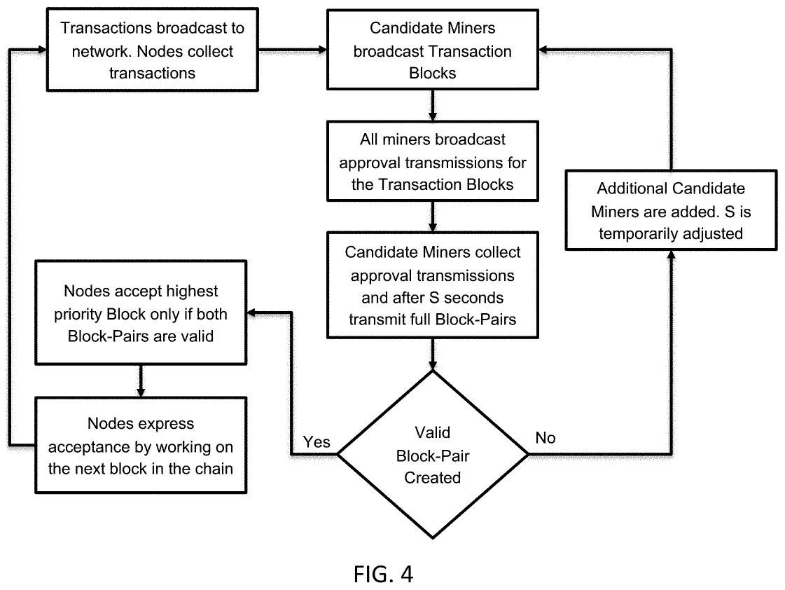

In most cases, the highest-priority block-pair is simply the block-pair created by the Validator highest in the ordered Validator list. However, if Vp is below 50%, a situation can arise in which a block-pair, BP1a for example, is validated, and another block-pair, BP2a, is built on BP1a and is also validated. BP1a is then final with respect to other parallel blocks. For example, if BP1b (which has the same parent block as BP1a) is received by a node after BP2a has been validated, BP1a will have priority over BP1b, even if BP1b was created by a Validator with higher priority. If parallel block pairs are proposed, where both are final with respect to parallel blocks, then the final block-pair from the Validator highest on the Validator list will have the highest priority. FIG. 4 is an illustration of an example consensus process.

The steps to run an example network are as follows:

(1) New transactions are broadcast to all nodes.

(2) Validators create and broadcast proposed block-pairs until a valid block pair is created.

(2a) Validators broadcast transaction components when it is their turn, which include received valid transactions.

(2b) All other Validators broadcast validation of transaction components in parallel.

(2c) Validators receive validations and broadcast validated components, which include both the transactions themselves as well as validation messages. The highest-priority valid block-pair becomes the next block in the blockchain.

(2d) If an acceptable block-pair is not found, the number of Validators proposing blocks and the timing between block-pairs are adjusted, and validation continues.

(3) Nodes accept the block-pairs only if both components in the block-pair are valid. Nodes establish the priority of any valid block-pairs to determine the correct chain.

(4) Nodes express their acceptance of the block-pair and indicate its priority by working on creating the next block in the chain, using the hash of the accepted block as the previous hash.

Not all transactions need to be received by all nodes. Transactions that are not received in time for the current block-pair will be added in a subsequent block-pair. Block broadcasts can also be missed without adverse effects to the chain. If a node determines it did not receive a block that other nodes indicate is current and validated, the node can simply request it.

Multi-Tier Blockchain and Sharding

One of the challenges in blockchain technology lies in the speed at which transactions can be recorded. For example, credit card networks can handle thousands of times as many transactions per second as most existing blockchain approaches. Some recent distributed ledger approaches have achieved much higher bandwidth, but they are untested on a larger scale and make other trade-offs. Embodiments of the present invention provide a methodology to allow for a number of on-chain trustless transactions per second that can surpass what even credit card networks can implement. These embodiments can enable scaling by sharding the network into second-tier blockchain networks. The example blockchain's use of Proof-of-Validation enables an innovative way to combine multiple tiers of blockchains that work together to scale, although the multi-tier embodiments described herein can be used with other distributed ledger and blockchain technologies as well. The approach can be thought of scaling the number of blockchain networks needed to reach a desired transaction per second bandwidth, and coordinating wallet balances between those networks.

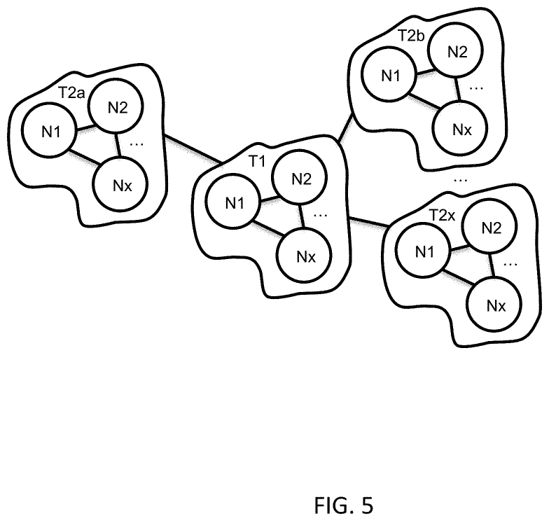

FIG. 5 is an illustration of an example multi-tier blockchain. The example blockchain's scalability is implemented through a multi-tier blockchain approach. It is based on a system where there is a Tier 1 Blockchain (T1) and many Tier 2 Blockchains (T2). The T2 networks are shards. T1 and T2 are comprised of independent nodes. The blockchains comprising T1 and each T2 comprise the entire blockchain implementation (where TN represents the individual blockchains T1 and all T2). Each TN is an implementation of the Proof-of-Validation consensus model described in this paper, in which transactions are validated by nodes in the respective TN using Proof-of-Validation.

T1 is unique in that it contains the full blockchain, receives transactions from the T2, has a longer block time and block size than T2, and contains a set of records that indicates “ownership” of wallets by each T2. Each T2 network is unique in that it manages only a subset of outgoing transactions for the full blockchain and transmits those transactions to T1 over time. Nodes for a given TN will not overlap with Nodes for a different TN in that they will not directly affect another TN's blockchain. T1 manages the full state of the blockchain itself as well as which portions of the blockchain T2s manage. T1 receives its transactions from the T2 blockchains, which are handling transactions for their designated, or owned, wallets. T1 and T2 communicate through cryptographically secured messages from their respective nodes. Messages can be sent from multiple nodes to help ensure they are received, and messages can require multiple node signatures for added security.

Through the use of T2 distributed networks, the total number of transactions per second can be scaled with the number of T2 networks. T1 is algorithmically load-balancing the work performed by the T2 networks. If a given T2 network can handle Nt transactions per second using Proof-of-Validation, then Nb T2 networks can handle Nb*Nt transactions per second. T2 networks also simplify and reduce the processing for T1. In order to achieve a minimum desired number of transactions per second, additional T2 networks can be added until the desired minimum is met. This is true given the assumption that T1 can effectively process the inputs that all of the T2s provide, but the T2s provide the primary validations on transactions and package data for T1, and T1 in essence is combining and recording the transactions validated by T2s. T1 block representations are optimized to put the majority of processing requirements on the T2 as described in more detail below. Additionally, T2 nodes can be geographically located for optimizing transactions across a geographic area, and T2 blockchains can have wallet ownership relating to that geographic area. A simple load-balancing algorithm can focus on establishing one or more T2 networks in a geographic location, where each T2 network handles a subset of the wallets associated with that region. A more complex load-balancing algorithm can include transferring ownership of wallets based on perceived patterns, such as wallets that commonly trade with each other.

T1 controls the primary blockchain, which is the ultimate record of currency or other asset ownership. The blockchain also includes another type of ownership representation, Wallet Designation (WD), in which each T2 has an address on the blockchain representing ownership/designation for standard wallets. The ownership refers to the wallets for which the given T2 network is designated to account for outgoing transactions. Wallet ownership in the blockchain is represented with non-fungible units, or special types of Smart Coins in the T1 blockchain, for WD purposes. These wallet-ownership Smart Coins can be administered in the same way as currency ownership, using validated transactions, and are transferred to the T2 addresses to represent that ownership. T1, and only T1, can transfer ownership rights for WD and therefore ownership for the T2. WD ownership can be manually adjusted by the INN where appropriate or algorithmically enhanced for optimal load balancing. Multiple nodes in T1 must validate any WD transfers as with any transfer. Additionally, multiple nodes in both the accepting and relinquishing T2s must validate a transfer in order for a WD transfer to take effect. This prevents discrepancies in which T2 has ownership over a wallet, and maintains the validity of the T2 blockchains. For a validation component in T1, which includes a WD transfer, to be valid, it must include validation messages from the T1 nodes, T2-accepting nodes, and T2-relinquishing nodes. T1 must reference the T2-accepting nodes' and T2-relinquishing nodes' active node lists, in order to validate the transfer transactions. If there are pending transactions in a T2 blockchain for a given wallet being transferred that are not yet reflected in T1, then the T2 will not validate a transfer, and the transfer will be delayed until all outgoing transactions for a given wallet are reflected in T1.

In a multi-tier approach, every wallet must have, and will have, only one T2 designation in order to be able to transfer currency or other assets. When a new wallet is created (i.e. when currency or another asset is sent to a previously unregistered wallet), then the newly created wallet will be assigned a blockchain in the WD. All transaction can validate the receipt of currency or other asset into the wallet, but outgoing transactions must be validated by an assigned T2. The T2 accepting the new wallet must indicate that it accepts the ownership, through validation messages from its nodes.

When a transaction is proposed by a wallet owner, that transaction is broadcast to the TN network. The T2 nodes handle the transaction as normal, with the added step that they only record the transaction if the sending wallet is one of their designated wallets in the WD. If it is not one of their designated wallets, then the transaction is invalid for that T2's purposes. Only the T2 with the designated sending wallet assigned to it can record the transaction in its blockchain. The transaction still must be validated in the T2 owning the sending wallet using the described Proof-of-Validation approach.

After a T2 transaction is recorded, then the transaction must then be recorded with T1. T1 obtains the state of all T2 blockchains as blocks are added, so T2 blocks are inputs for the T1 blockchain. The transaction validation for T1 is simplified given the transactions themselves have already been validated in a T2 Proof-of-Validation process. T1 validates T2's block validation signatures. Because T1 is ultimately receiving all transactions that all T2 networks received, as the number of T2s grow in number, it can require more time to process all of the transactions. T1 can use different parameters than the T2, a faster network connection, and T1 nodes can be comprised of computers that have more processing power than T2. A transaction is considered valid when it is Validated by a T2. Each T2 is secure in its own right as it represents a fully functioning and secure blockchain. It should be noted that the T2s are not consolidating transactions. They are simply collecting and validating transactions, and all T2 transactions are eventually recorded by T1.

As the T2 networks grow in number, a greater amount of information is processed by the T1 network. T1 must be able to process all T2 transactions in order for the system to continue to operate efficiently and prevent a backlog of T2 transactions coming in to T1. The T1 blockchain does not independently validate all transactions. Instead, it validates T2 blocks as its inputs, which are assured to be valid since they are coming from full blockchain implementations. T2 networks package data in their blocks so that T1 can include and validate it more efficiently, putting more of the validation load on the T2 networks. For example, T1 nodes can reference a hash of entire T2 blocks that include a simplified representation of wallet balance updates, and include that simplified representation of transaction results, where the T1 nodes therefore validate on a per block basis (i.e. T2 blocks) rather than on a per-transaction basis. T1 Merkle trees are built with T2 blocks rather than individual transactions in this approach as well. All transactions are still recorded, however, given the summary of transactions in the T2 blocks, which can be represented as a chain state vector. Additionally, a simplistic broadcast model from T2 to T1 also can create a problem for long-term growth, and communications between T2 and T1 will also need to be optimized, which can be controlled in the peer-to-peer network given the Proof-of-Validation approach. In another optimization, there can be different types of nodes, including full nodes and basic nodes. Full nodes maintain a full copy of the entire blockchain. Basic nodes contain a working copy of the current state of ownership. Basic nodes implement validation and consensus, and maintain a validated state based on the full node blockchain record. Full and basic nodes can exist on both T1 and T2.

With each T1 block added to the blockchain, the T2 nodes will need to verify and update their assigned wallets in the WD as well as include incoming transactions for their assigned wallets, which come from the T1 blocks. T2 nodes obtain updates from the T1 as incoming transactions into their network, for wallets they own. T2 networks must view all of the transactions occurring in T1 blocks, and add relevant transactions (that are being transferred into their WD owned wallets) into their blockchains as inputs into their wallets. Incoming transactions into a T2-based on a T1 block are not validated in the same way as an outgoing transaction. An outgoing transaction is validated if a wallet contains enough currency to allow the transaction and the transaction has a valid signature. An incoming transaction is validated if the T1 containing that transaction is a valid and verified T1 block. Once an incoming transaction is verified as a valid T2 block-pair, and is therefore added to the T2 blockchain, the currency or asset is considered received and a new balance in the wallet is reflected. For example, if an amount of currency is transferred from Wallet A to Wallet B, then Wallet B will not be able to transfer that currency until the T2 associated with Wallet B is updated with the Wallet B value from T1. There is a limit to the number of transactions per second of both incoming and outgoing transactions for users, but the limit is similar to that of credit card usage. Many outgoing transactions can be recorded in a T2 wallet, up to the amount that the T2 understands the wallet currently holds, which is analogous to a credit limit for credit card transactions. That amount, or credit-limit-analogy, can be updated at a slower pace, based on T1 updates that are ultimately validated as incoming transactions in T2.

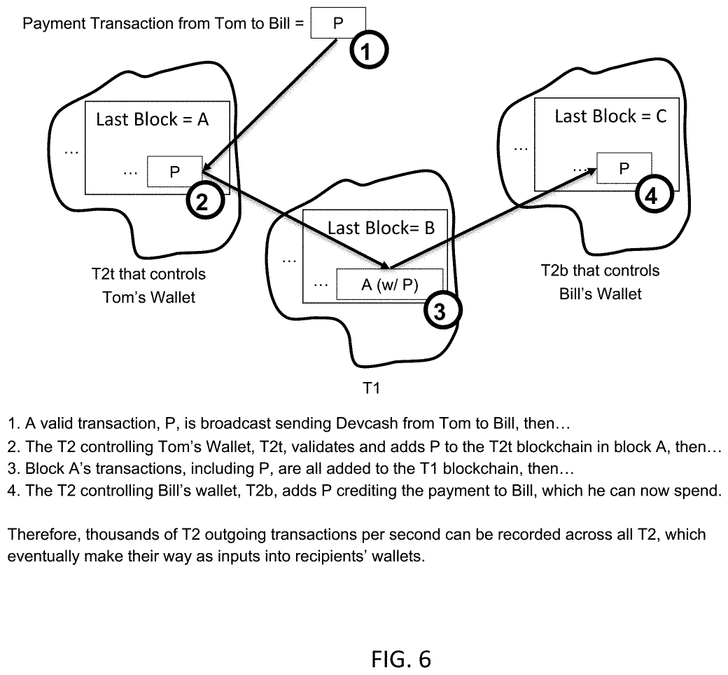

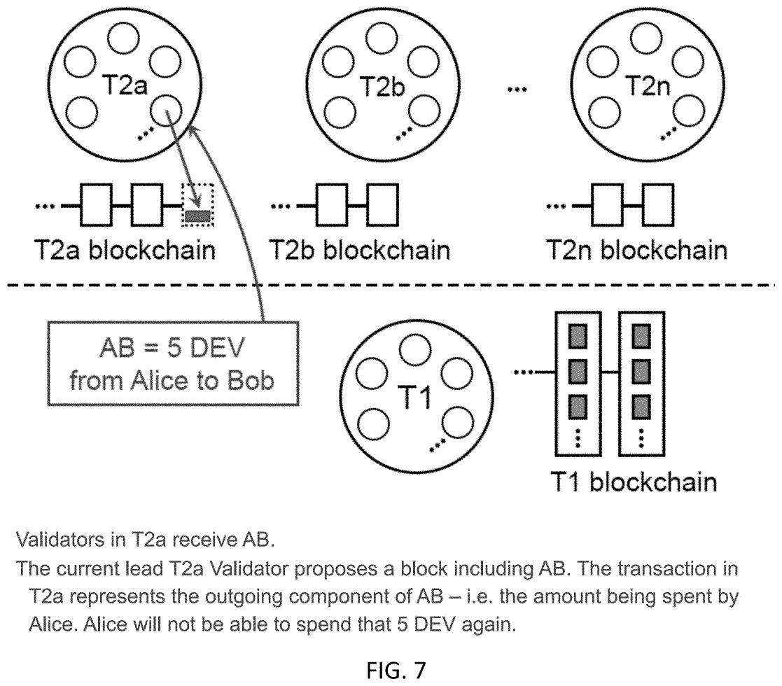

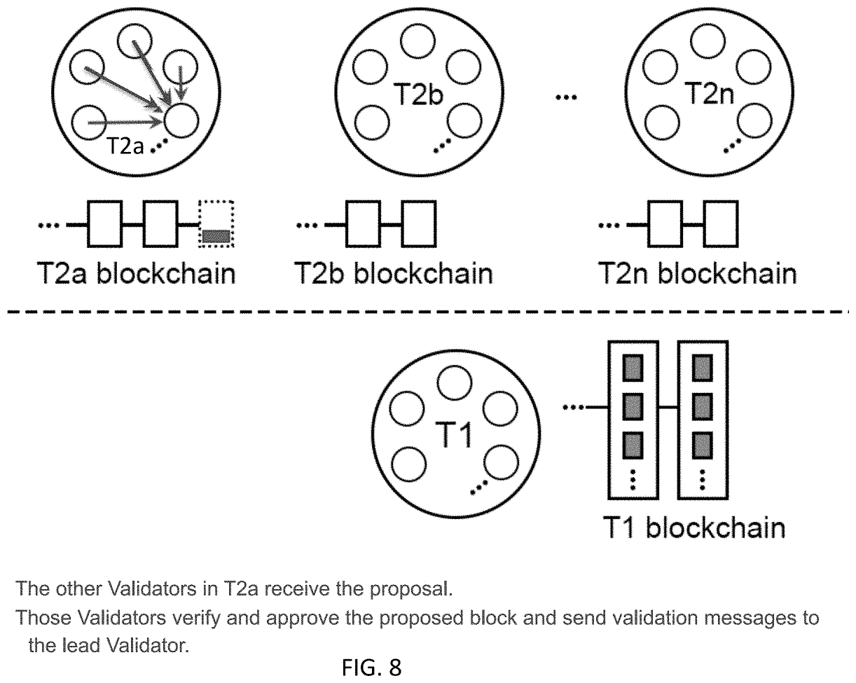

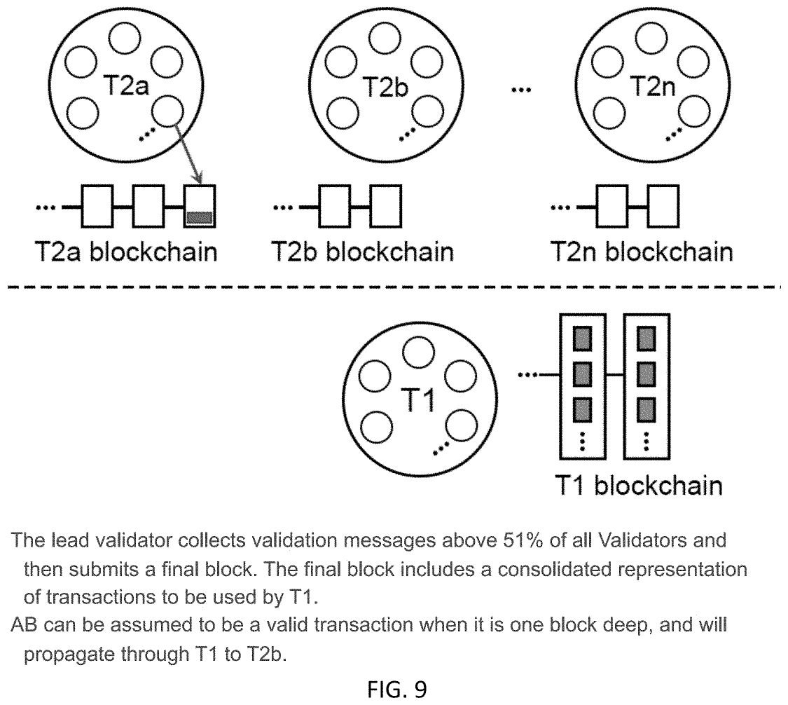

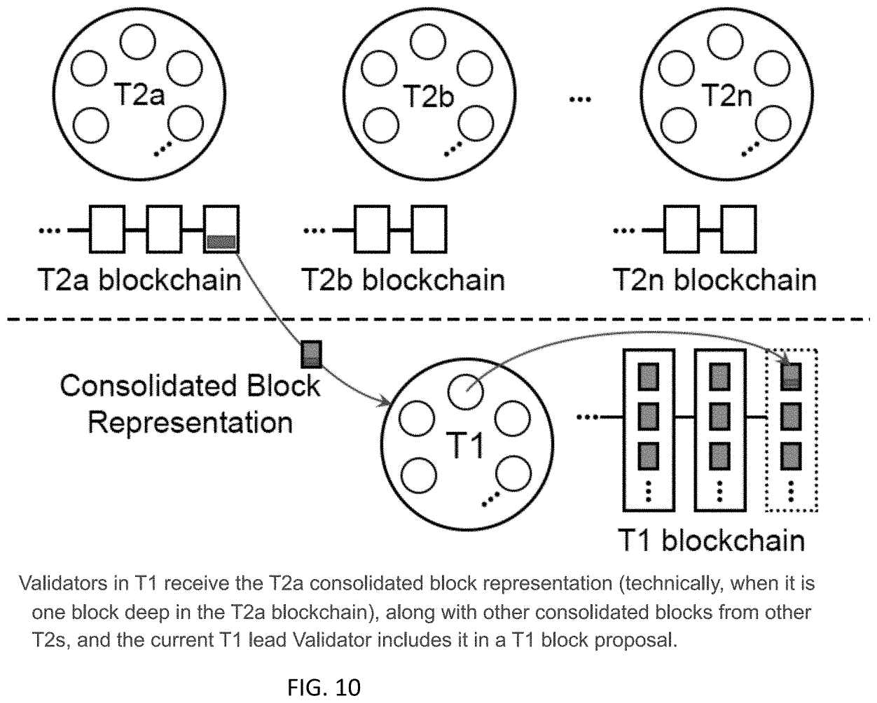

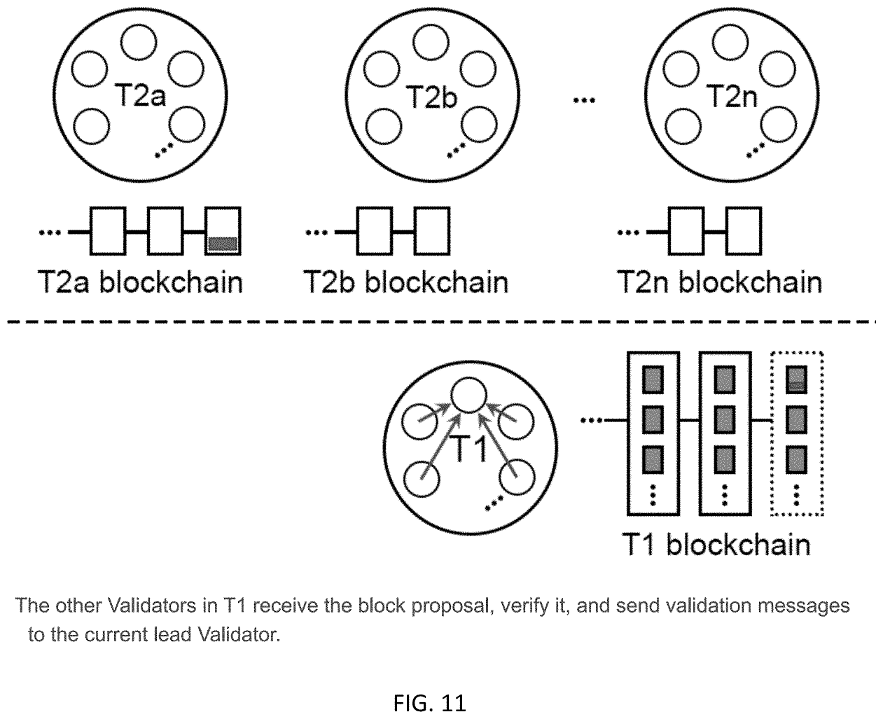

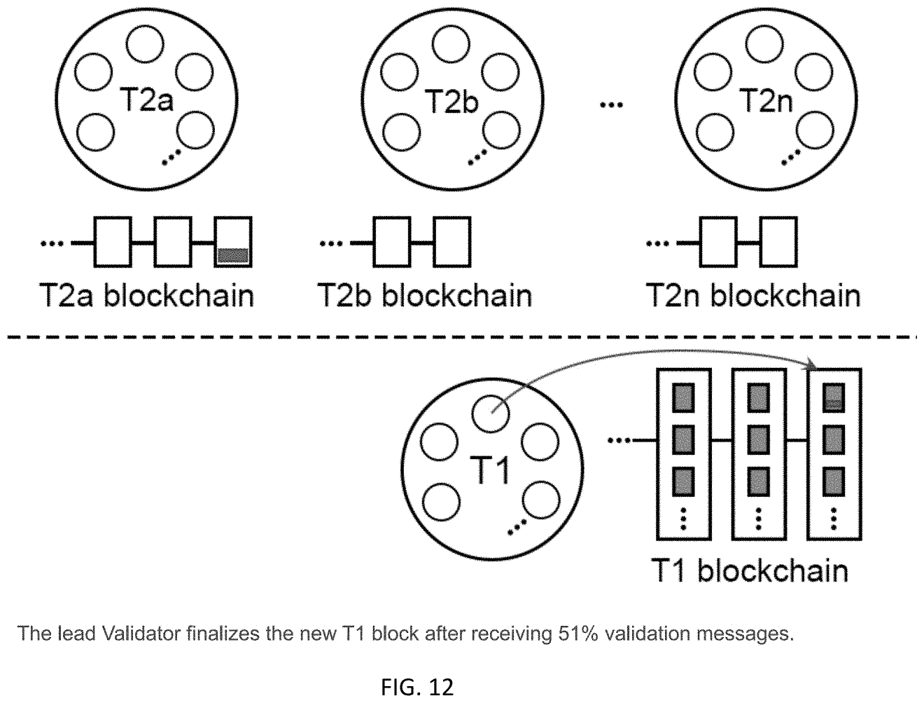

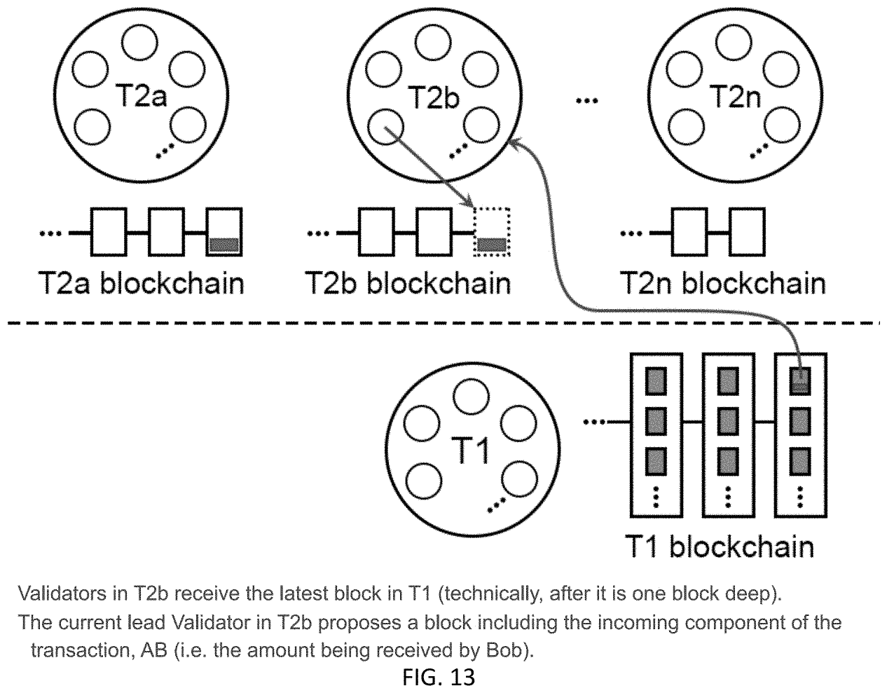

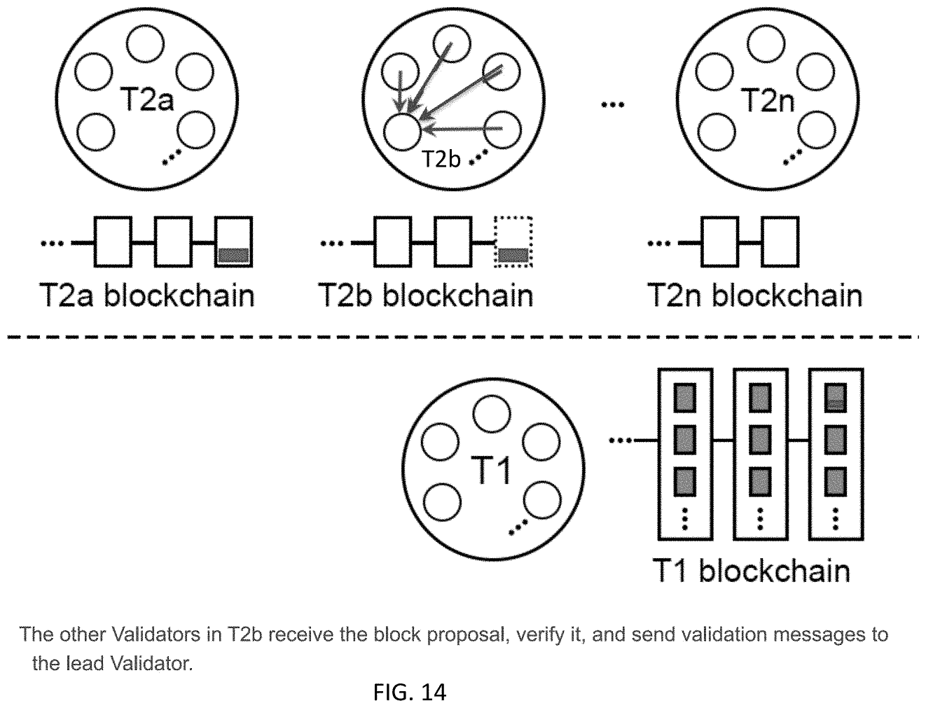

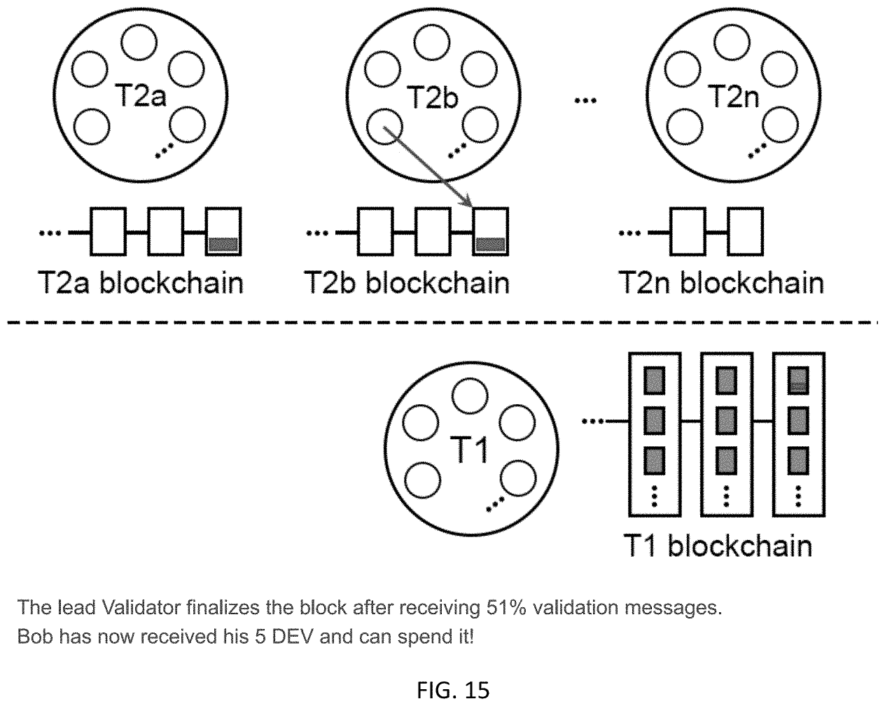

FIG. 6 is an illustration of this transaction methodology.

(1) A valid transaction, P, is broadcast sending currency from Tom to Bill, then . . .

(2) The T2 controlling Tom's Wallet, T2t, validates and adds P to the T2t blockchain in block A, then . . .

(3) Block A's transactions, including P, are all added to the T1 blockchain, then . . .

(4) The T2 controlling Bill's wallet, T2b, adds P crediting the payment to Bill, which he can now spend.

Therefore, thousands of T2 outgoing transactions per second can be recorded across all T2, which eventually make their way as inputs into recipients' wallets.

T2 networks maintain an accurate state of outgoing transactions, and a transaction in a T2 blockchain can be considered a validated transaction. T2 blockchains do not immediately receive incoming transactions from wallets owned by other T2 blockchains into their assigned wallets, since the incoming amounts come from T1, so they do not always maintain an accurate representation of account balance in their respective blockchains (they might reflect an underestimate, but never an overestimate). However, any discrepancy only means there will be a small delay in time until funds are available to be spent. This creates a limitation when currency is transferred into a wallet and is immediately desired to be transferred out of the wallet; however, this is already an acceptable limitation in real-world use, especially given delays are on the order of seconds. The multi-tier blockchain approach therefore allows much larger numbers of transactions per second, with the limitation that incoming amounts that replenish a balance can take more time (on par with a single-tier blockchain). This is an effective solution for significantly increasing the number of transactions per second that the blockchain can handle, as that type of transaction scheme fits real-world usage, and is analogous to credit card usage or bank accounts. Moreover, the vast majority of transactions in a system occur from accounts that have a balance, where the balance is replenished over time and not spent immediately as it is replenished (e.g., the balance is replenished by paying off a credit card, or receiving a paycheck into a bank account).

The steps to run an example network are as follows:

(1) New transactions are broadcast to all nodes.

(2-1) T1 Validators create and broadcast proposed block-pairs for the T1 blockchain until a valid block-pair is created.

(2-1a) T1 Validators broadcast transaction components for the T1 blockchain when it is their turn, which include received transactions intended for the T1 blockchain from T2. These T2 transactions are validated T2 blockchain blocks.

(2-1b) T1 Validators broadcast approval of transaction components in the T1 blockchain.

(2-1b2) T2 Validators broadcast approval of T1 transaction components that include transfers of ownership of wallets related to the T2.

(2-1c) T1 Validators receive those approvals and after Svt1 seconds broadcast validation components for the T1 blockchain, which include the validation messages.

(2-1d) If an acceptable block-pair is not found, the number of T1 Validators proposing blocks and the T1 timing between block-pairs are adjusted, and validation continues.

(2-2) T2 Validators create and broadcast proposed block-pairs for their respective T2 blockchains until a valid block-pair is created.

(2-2a) T2 Validators broadcast transaction components for their T2 blockchain when it is their turn, which include received transactions designated as outgoing transactions for their owned wallets in their T2 blockchain. Transactions also include T1 transactions that were validated and added to the T1 blockchain with receiving transactions for wallets designated to the given T2.

(2-2b) T2 Validators broadcast approval of transaction components in their T2 blockchain.

(2-2c) T2 Validators receive those approvals and after Svt2 seconds broadcast validation components for their T2 blockchain, which include these validation messages.

(2-2d) If an acceptable block-pair is not found, the number of T2 Validators proposing blocks and the T2 timing between block-pairs are adjusted, and validation continues.

(3-1) T1 Nodes accept the T1 blockchain's block-pairs only if both blocks in the block-pair are valid. Nodes determine the priority of any valid block-pairs to determine the correct chain.

(3-2) T2 Nodes accept their blockchain's block-pairs only if both blocks in the block-pair are valid. Nodes determine the priority of any valid block-pairs to determine the correct chain.

(4-1) T1 Nodes express their acceptance of the block-pair and indicate its priority by working on creating the next block in the chain, using the hash of the accepted block as the previous hash.

(4-2) T2 Nodes express their acceptance of the block-pair and indicate its priority by working on creating the next block in the chain, using the hash of the accepted block as the previous hash.

Finally, three (or more) tier blockchain approaches are possible with this approach as well. Each T2 can “act as a T1” for its children blockchains, T2-1, T2-2, etc. Where T1 is a parent blockchain for T2, T2 can be a parent blockchain for T2-1, T2-2, etc. Each parent blockchain can maintain state of ownership for wallets for its children. In a multi-tier blockchain, with 3 or more tiers, T1 is still the ultimate representation of ownership.

Proof-of-Validation Analysis

The Proof-of-Validation approach provides practical scalability, transparency, and integrity to the consensus-building process. Transparency and visibility are keys to its operation and success, as that transparency ensures overall system integrity. Anyone can audit the system at any time.

With Proof-of-Validation, Validators have a fairly straightforward role: simply maintaining the growth and integrity of the blockchain through consensus. Where many blockchains utilize a clever approach that allows anyone to become a Validator, the trade-off in that approach comes with the negative aspects of Proof-of-Work models such as high energy usage, difficulties in governance, scalability, overall system costs, and the usual trend of moving towards a consolidated and limited number of Validators with the high level of specialized processing hardware needed.

The example system's approach strikes a balance in maintaining an immutable blockchain while allowing long-term growth, and provides the following advantages.

Transparency: The blockchain is always available for anyone to view and audit for verification of its integrity. Even though Validators are permissioned, they simply perform a deterministic role that anyone can verify is being performed correctly. The algorithms that Validators used are visible at any time by anyone. Similarly, the rules that govern blockchain operations are visible at any time by anyone.

Immutability: Blocks are built on a chain that consecutively references each prior block as the chain grows. The blockchain is built in a linear progression where each block references the previous block. The blockchain is available for everyone to see, and it cannot be changed under any circumstances.

Trustless transactions: Transactions are implemented with cryptographic protection using public-private keypairs. Anyone can verify that the publicly available blockchain is indeed recording valid transactions and that no double spending occurs. Transactions cannot be reversed or forged. Validators are incentivized to include all valid broadcast transactions. Anyone can perform their own audit on the blockchain and any relevant transactions.

No central authority validating transactions: It is important to understand that with the example approach, even though Validators are permissioned, there is still no central authority validating transactions. GOV can add or remove Validators, but all Validator actions as well as the blockchain itself are handled algorithmically, with open source algorithms, verifiable by anyone. If Validators fail to perform duties or attempt to attack the system, they will be replaced, but the collective actions of the Validators are performed based on transparent and verifiable criteria.

Security: Because the blockchain is maintained by many different nodes in a peer-to-peer network, it retains all of the security benefits of other blockchains. A small number of compromised nodes will not lead to a failure in the system as a whole.

Resistance to collusion: Because Validators' actions are visible, and Validators are selectively chosen, collusion would be extremely difficult. Any activity based on collusion would be easily detected given the visibility of the blockchain itself, the transparency of operations, and the ongoing validation of the correct blockchain. Any large-scale theft or manipulation, even if successful, would be undone under the transparent rules of the blockchain's operations. Conceivably, one could argue that GOV itself could be part of collusion with Validators, but transparency likewise prevents such an occurrence. If a nefarious activity were implemented by GOV, it would be easily detected. Large strings of the blockchain cannot be changed, because anyone can see the blockchain at any time, and unauthorized changes would easily be detected. Any nefarious activity committed by GOV would also work to undermine the value of the currency and the blockchain itself, thus reducing the original incentive to perform the activity. The transparency with which the currency and the blockchain is governed and operated along with the ongoing transparency of the resulting blockchain, create a system that is more resistant to collusion than other approaches. For example, Proof-of-Work blockchains have evolved to a state where fewer and fewer entities have Proof-of-Work capabilities, leaving control of consensus on the blockchain in the hands of fewer and fewer miners, significantly increasing the risk of collusion.

A significant trade-off between Proof-of-Work and Proof-of-Validation is in censorship resistance. In most approaches where anyone can become a miner, and where there is no central representative permissioning miners, the overall system is indeed censorship-resistant. This censorship resistance is an illusion, however, when it comes to mass adoption. For a system to be adopted on a mass scale, it needs to adhere to the laws of the countries in which it is used. This has proven true in cryptocurrency growth to date. In order to achieve mainstream use of a cryptocurrency worldwide, users must be able to exchange the cryptocurrency with fiat currencies, and these exchanges are systematically regulated across the globe. Proof-of-Validation therefore has the same end result as other approaches with respect to censorship, but allows many advantages that are not possible when anyone can become a miner.

Proof-of-Validation Consensus Example

This section describes an example of the Proof-of-Validation Consensus Algorithm for the example system to further illustrate its operation. The description following gives more details and specifics on the algorithms used for the Bob-Alice transaction shown in the diagrams.

Assumptions relative to the example:
There are n T2 networks and 1 T1 network.
In the diagrams, the T1 and T2 networks and their blockchains are shown, and include representative
Validator nodes within each network.
Alice's wallet is designated to the T2a network.
Bob's wallet is designated to the T2b network.
Proposed blocks are shown as dashed lines.
Finalized blocks are shown with solid lines.
The Alice-to-Bob transaction, AB, is shown in green.
Each step as it is performed is shown in red.

This example assumes a network of N active mining nodes {Validator 1, Validator 2, . . . Validator N}any or all of which can receive transactions at any time. Validators are pseudo-randomly ordered after each block, in order to create the next block. This process can be tuned and calibrated by the INN using several parameters, as examples:
N—The number of active Validators (modified by adding/revoking certificates)
Nv—The number of Validators initially proposing block-pairs. For this example, we assume Nv is 1.
Pt—The time when additional Validators propose blocks if no proposal was received.
Vp—The percentage of Validators that must validate a transaction block to be accepted. For this example, we will assume Vp is 51%.

Single-Tier Blockchain Description

The Validators follow this algorithm in a single-tier blockchain to achieve consensus rapidly:

1. Determine a pseudo-random list of Validators (See Validator Ordering Algorithm below.) Each Validator independently maintains this deterministic ordered list, L, of active Validators. For simplicity, let L be described with consecutive indicators of V1 as the first Validator in L through VN as the last Validator in L.

2. The ordering determines a lead Validator, V1 who submits a proposed transaction component of its block-pair. Other Validators will wait Pt seconds for V1's proposal. If any Validator has not received a proposal after Pt seconds, it will check L to determine if it should propose a transaction component. In this example, V2 and V3 should simultaneously propose a transaction component if V1 fails to do so or is hindered from doing so. If another Pt seconds passes without receiving any transaction components, the following 4 Validators in L {V4,V5,V6,V7} should propose transaction components. This process continues as necessary, doubling the number of Validators proposing blocks each Pt seconds until all Validators have submitted proposals for transaction components. This continuing increase in the number of Validators submitting proposals occurs to avoid a denial-of-service attack. Under normal circumstances, this step will succeed on the first attempt with V1 proposing a transaction component.

3. Let VP be the lowest Validator in L that is proposing a transaction component (for example V1 in normal operation) and let TC be its proposed transaction component of its block-pair. VP constructs TC by including all valid transactions it is aware of that have not been encoded in the blockchain already, along with a Merkle Tree built with all of these transactions. Transactions include at a minimum, the sender's public key, the recipient's public key, the asset to be transferred which is usually an amount of currency, and a signature for the transaction created with the sender's private key. Then, VP broadcasts TC to all active Validators in L. Any other Validators, if any, currently proposing transaction components do so in parallel with VP.

4. Let TC be received by arbitrary Validator, VA, where VA is not the Validator that proposed TC. VA verifies TC by validating all individual transactions and validating the Merkle Tree of TC. All Validators maintain a summary of wallet balances across all wallets in their blockchain, which is updated with each block added to the blockchain. The summary of balances can be recreated at any time by anyone from the blockchain. This summary of balances is used to verify that a sending wallet is able to implement the transaction. For example, if 5 currency units are being sent from Alice to Bob, the balance summary is used to confirm that Alice indeed has 5 currency units to send. It is also used to determine whether there are any other restrictions on sending the transaction, such as a restriction indicated by a Smart Coin. Additionally, a transaction is verified to have a valid signature. To verify the Alice-Bob transaction, VA uses Alice's public key to decrypt Alice's signature, which produces H1. Then VA hashes the Alice-Bob transaction, which produces H2. If H1 equals H2, then the transaction is appropriately signed. If the transaction is appropriately signed and the sender has an adequate balance and no restrictions, then the transaction is valid. VA validates all transactions in TC. Further, VA validates any other proposed transaction components from other Validators sequentially, based on the order given in L. If no transaction components have been received and Pt seconds have elapsed, then VA checks L to see if it should propose a transaction component. If TC is valid, VA generates a validation transaction that includes TC's ID (which is its hash, provided by VP) encrypted using VA's private key, which is a signature on the validation. It sends this validation transaction, including the signature, back to VP. Anyone else can use VA's public key to verify that VA's validation transaction was itself valid.

5. Once Pt seconds has elapsed and VP has received greater than Vp valid signatures, it creates a validation component by including all validating transactions along with a Merkle Tree based on those validating transactions. Then, it creates a Merkel root based on the Merkle tree for the transaction component (TC) and the validation component that it just created. Finally, it broadcasts this finished block, FB, to be added to the chain. Other Validators who are proposing blocks, if any, also collect validations and propose final block-pair candidates.

6. Validators express their approval of a block being added to the chain, in this example FB, by continuing to work on the highest-priority block (i.e. the valid block-pair created by the Validator in the lowest position in L). Any other block-pair candidates, which are short branches in the blockchain, are discarded even if they have been validated. The final blockchain is linear and all Validators eventually work on the same branch as each block is added.

Multi-Tier Blockchain Adjustments

The following modifications represent an example multi-tier blockchain solution.

T2 provides consensus as described in the single-tier example above; however, T2 additionally prepares data for T1. In the final construction of a validated block-pair, a simplified and summary description of the block's transactions is created, which later becomes an input into T1. The simplified version only contains the aspects of transactions material to ownership, such as sending address, receiving address, and amount transferred. It does not include signatures, as the transactions for T1's purposes have already been assured to have been validly signed. In the above example when in a T2 context, VP would add the summarized transaction representation, ST, to the finished block FB. T1 will receive all blocks from all T2s as inputs, and use ST for each block as the representation for its input transactions. ST's format organizes all transactions into packaged groups, each a PG, based on where each T2 recipient is located as defined in the T1 Wallet Designation. Each PG is signed by VP in creating ST. The sum of all PGs along with their signatures comprise ST. All transactions are therefore included in the PGs and each PG contains all transactions that will become inputs for a given T2.

T1 also provides consensus as described in the single-tier example above, but with different modifications. For T1, “transactions” are the T2 summary transactions ST at the point in time when they are assured not to change (e.g. blocks that are 2 deep in the blockchain). T1's transactions therefore are fewer in number but larger in size. T1 validates STs coming from the T2 blocks using the T2 block digital signatures associated with all PGs. In T1's validation, as described in Step 4 above, the process does not include a balance check. The validation is only a validation of the PG signatures themselves. The Merkle Trees for T1 blocks are also therefore comprised of the STs from the T2 blocks. T1 block sizes and block times are increased compared to T2.

Finally, T2s parse T1 blocks as input transactions for their blockchains. For each block added to T1 at a level it is assured not to change (e.g. blocks that are 2 deep in the T1 blockchain), each T2 parses the block and utilizes the PG relevant to it, as inputs. These input transactions are only validated by signature, not by balance, as they are assured to have valid underlying balances from the original T2 validation. In this way all transactions are ultimately received by wallets as incoming transfers recorded in a PG, and all T2 are synchronized.

Example Data Structures

This section describes data structures used in an example protocol. Generally, the data on chain will be encoded in CBOR where each block is a bytestream. A scanner can translate the chain into more human-readable JSON where signatures and keys will become longer hex strings.

Block Structure:

Blocks in the example blockchain protocol are defined as follows:

Headers
(1) Protocol version (1 byte until v23, initial version will be ‘0’, field grows as needed).
(2) Previous block's SHA-256 hash.
(3) This block's Merkle root—from the hash of transactions and the hash of validations.
(4) Blocksize—generated by the finalizing Validator after sufficient validations.
(5) Timestamp—UTC time added by the finalizing Validator as it finishes a block. It should be noted that timestamps are not precise or synchronous, time can be used roughly for reversible currency and to generate nonces if needed. Time is not used for Validator coordination or ordering.
(6) Transaction bytesize—the size of all transactions in bytes (not a count of transactions to help avoid length extension attacks).
(7) Validation bytesize—similar to above, the length of the validation section in bytes

Body

The body of a block contains transactions and validations as described below.

Transaction Structure (T1):

Each transaction is represented as a JSON object with the following fields that constitute the abstract ‘Smart Coin’ pattern. Arbitrary Smart Coins can be created, modified, or deleted by the INN and exchanged by any addresses from the perspective of T1.
(1) oper: an operation enum, one of [‘create’, ‘modify’, ‘exchange’, ‘delete’].
(2) type: a string representing the coin type (dcash, data, id, vote, etc).
(3) xfer: an array of objects defining coin transfers in the transaction, with the following subfields:
(3a) addr—32 digit base64 address, based on sender's public key, hashed and truncated.
(3b) amount—amount of coins to move (<0 means send, >0 means receive).
(3c) nonce—8 bytes arbitrary data to prevent replay attacks (required for sending).
(3d) duration—a time in seconds used for reversible currency functionality. It is a time duration relative to the timestamp of the block when it gets put into the chain. Until the duration is complete, this transaction can be reversed or modified by the INN and the recipient cannot transfer a token.
(3e) sig—72 byte ECDSA signature (required for sending).

Validation for a Transaction

A transaction is valid only when all of the following statements are true:
(1) The sum of all xfer.amounts is exactly zero.
(2) Each signature in the transaction must validate against its respective public key.
(3) For ‘exchange’ operations, for each sender, the amount value must exactly equal the current chain state for this address and coin type. Change is made by having an address twice, as a sender and receiver.
(4) For ‘create’, ‘modify’, and ‘delete’ operations, there must be a xfer signed by the INN.
(5) In the case of create, the positive addresses are the targets for the new coins.
(6) In the case of modify, the positive addresses are the target coins to modify.
(7) In the case of delete, the negative addresses are the target coins to delete. Note: the INN can use this capability to garbage collect coins that have completed their lifecycle. For example, after storing data via an exchange operation, data coins can no longer be used again and the INN should delete them to prune the chain state. (A T2 pruning shard can manage this.)
(8) In the case of a non-zero duration value, reversible currency functionality (indicated by a reversible currency—available or reversible currency—wallet Smart Coin) must be available.

Any other elements in a T1 message will be ignored (for example data or api elements); these are assumed to be validated by T2 nodes.

Transaction Structure (T2)

Each T2 Validator has at least 1 oracle that translates transactions from a more specific syntax into the T1 syntax described above. Oracles can be composed into validation DAGs where the outermost oracle(s) pass valid transactions on to more fundamental oracles that reject invalid transactions. In some examples, all T2 nodes can have all of the implemented oracles, so they can operate fully in parallel.

For example, an outside “insurance claim” type may include “data” coins and “dcash” coins. The external insurance oracle (hosted externally) validates claims and passes valid claims to T2, which validates the data and dcash objects within the complex claim object. If the claim object is fully valid according to those validators, the resulting transaction is encoded in the relevant shard chain and passed on to T1 for final encoding.

Validation Transaction Structure

Each validation transaction (sent by a Validator who is validating a transaction component of a block-pair), is a key-value pair representing the Validator's ECDSA signature on the transactions.

The key identifies a Validator using a URI where the initial format will be “protocol://[shard]/[unique name]”. The URI schema can be dropped for brevity during internal usage, for example, “t1/Validator1” is sufficient for identifying Validator1 in t1 within the T1 chain, but “protocol://t1/Validator1” should be used when there is potential for ambiguity with other URI schemes.

The value is a bytestring of the two ECDSA integers encoded in DER format. When translated to JSON, the signature becomes a hex string.

Example (base64 CBOR with DER bytestrings, how it appears on chain, ignore whitespace): oWt2YWxpZGF0aW9uc6JpdDEvbWluZXIxwIhGMEQCIHG+P2fzJLRF0ku0ZqO/72dPy4hx S+tp5X0dXkujeg07AiBKCPqItwUOtu9LDkuxKsjyE9oankUSZTCIQLY8MeFESmI0MS9taW5IcjLCWEYwRAIgJYKJTpkrpAhmZGqzQK4XwHbtWQD4IZyphjWqUf8+Yh8CIBjEI8zCilIw1en SeNLJuGyZS9pRPHtOSBgazH97rzjI (240 bytes)

Same example (more human-readable JSON with hex strings):

“validations”: {
“t1/Validator1”:“3044022071be3f67f324b445d24bb466a3bfef674fcb88714beb69e57dld5e4ba37a0d3b
02204a08fa88b7050eb6ef4b0e4bb12ac8f213da1a9e451265308840b63c31e1444a”,
“t1/Validator2”:“304402202582894e992ba40866646ab340ae17c076ed5900f8219ca98635aa51ff3e621f0
22018c497ccc28a5230d5e9d278d2c9b86c994bda513c7b7448181acc7f7baf38c8”
}
(325 bytes)

Oracles and Coins

Below are some example initial coin types and oracles.
dcash—a basic irreversible cash transaction.
drevwallet—transactions related to managing a wallet required to use a specific currency.
drevavailable—transactions related to managing a wallet that may use reversible currency.
vote—a vote transaction.
id—an identity referencing transaction.
data—a wrapper for arbitrary data, each data coin provides up to a specified amount of space on chain.
api—a wrapper to manage permissions for external interfaces.

Any other data types should be sent to a T2 node with the api oracle, which will check that the type is registered. Unknown types will be rejected by T2.

The following section describes an oracle that validates each T2 coin type.

Currency. currency transactions manage the basic value transfers of currency. They do not require any additional fields beyond oper, type, and xfer as described above.

Validation:

Considering all currency transactions on chain, for each sender, the amount value must exactly equal the chain state for this addr and coin type, which is all of the create/exchange operations minus the sum of all currency send transactions for this addr and type in the chain.

If any sender has a drevwallet coin in the current chain state, this transaction is invalid.

Drevwallet. This is a coin that indicates a wallet must use reversible currency instead of other currency.

Validation: An address can only hold 0 or 1 drevwallet coins.

Drevavailable. This coin works like a drevwallet coin, but it allows a wallet to use reversible currency or other currency.

Vote. These coins are used to vote and manage elections.

Vote also has the following additional fields: election: an address specifying which election this coin belongs to (generated by the INN). targets: an array of addresses where this coin may be exchanged (the election candidates).

Validation:

Targets are only allowed to be specified when the operation is create or modify.

During ‘Exchange’ operations, the receiving address field(s) must be one of the targets specified in the highest ‘create’ or ‘modify’ transaction in chain for this election.

Each sender in an Exchange operation (the act of voting in this case) must have been a receiving address in the highest transaction on chain for this election. Note: This defines their eligibility to vote. This can be extended to support different election types where some addresses get more votes than others or each address has exactly one vote, as specified by the amount field.

Id. The id coin is used by the INN to associate an address with a specific identity for a specific timeframe.

Additional fields:

idRef: a string that references identifying information held by the INN.

duration: a positive integer, the number of seconds until this ID expires, after that it needs to be verified by the INN again (the default will be 1 year, 31536000 seconds).

Validation:

An id may not be exchanged by its holder. ID coin transfers are implemented by the INN.

idRef must have valid syntax and must be known to the INN based on a webservice call, and the duration must be within the specified bounds

Data. The data coin allows the capability to store arbitrary data. The default cost will be a maximum of 10 kilobytes of arbitrary data per data coin. This can be used to store literal data or a reference to an INN data store.

In terms of lifecycle, an address may request data coins from the INN (which will control permission, payment, etc.). After that process, the INN will create data coins at that address. The user can exchange the coins with any address to store the data on chain. Later, the INN can delete those coins to prune the chain state.

Extra fields:

data: a bytestring of arbitrary data

Validation:

Amount must be greater than the length of the data field divided by the data coin value (currently 10,240 bytes).

Amount must be less than or equal to the sum of data coins created at this address minus the sum of coins exchanged by this address. Data coins can only be used once.

Api. API coins manage permissions for external interfaces, such as external oracles or wallets.

These are currentlly the same as ID coins. They have a reference to identifiers with the INN and a duration. An address must have a valid api coin or else T2 nodes will reject unknown transaction types sent by that address.

Validation:

idRef and duration must pass input validation.

Transactions from the external source must include an ECDSA signature for non-repudiation.

After encapsulating unknown fields, the api oracle can decompose the remainder of the message into the types listed above and each oracle will validate that portion of the overall transaction. If any oracle rejects any part of the transaction, the entire transaction is rejected.

Messages and Variable Types

There are a number of message types that can be common in an example network. The following list shows common messages. These messages are all digitally signed.

Transactions: Transfers of currency ownership. These are digitally signed by the wallet owner.

Transaction Component Proposals: The first block of a block-pair which includes collected Transactions. These are digitally signed by Validators.

Validation Component Proposals: The second block of a block-pair which includes collected Validation messages. These are digitally signed by Validators.

Validation Messages: Messages sent to validate a block. These are digitally signed by Validators.

Mining Participation: Messages sent to indicate active participation. These are digitally signed by Validators.

INN Parameter Definitions: Messages that define operational parameters. These are digitally signed by the INN.

Community Voting: Messages used for GOV governance. These are digitally signed by owners.

Smart Coin Issuances: The INN can issue Smart Coins under given Smart Coin rules, such as with Identity Smart Coins or Voting Smart Coins.

reversible currency Transactions: A transaction can be implemented as a reversible currency transaction rather than a straight currency transaction.

reversible currency Reversals: Transactions made with reversible currency can be reversed by the INN, including for fraud on a transaction or theft from a reversible currency Wallet. The INN can also initiate a transfer for a lost private key in a reversible currency Wallet, and that transaction can be reversed by the user as an owner protection.

Private Transactions: Transactions sent to the INN for a private transaction.

Dallocation Transactions: Transactions sent by the INN adjusting a Dallocation for reconciliation with immediate transactions.

Loan/Credit Payment: Transaction that adjusts a Loan or Credit Smart Coin balance from currency funds.

The following are common operational parameters that can be modified by the INN. These parameters can often only be modified within defined constraints. For example, there is a maximum reward for a block-pair (i.e. a maximum for the sum of Rb, Rn, and Rt). This is not changeable by the INN, other than with a Quorum.

Ar: activationRounds—a parameter that determines how many rounds occur between activation blocks. A round is a number of blocks equal to the number of active Validators.

Pt: proposalTimeout—a timeout period for block proposals, if a proposal does not arrive within this timeframe, the next backup Validators should broadcast their proposal.

Vp: validationPercent—the proportion of validations needed for a final block (51% by default)

Bt: Block size for the transaction portion of the block-pair

Cr: Number of required connections nodes must maintain to remain active

Rbf: The base reward going to Validators for a block-pair validation

Rnf: The bonus reward for full node Validator participation

Rtf: The asymptotic bonus reward for including more transactions

Nc: The number of INN control nodes, maintaining operational rules

INNc: The number of messages that must be independently received from transmitters for a INN message to be considered valid

Nf: The number of full nodes

Nb: The number of basic nodes

NT2: The number of T2 blockchains for a multi-tier blockchain approach

Multi-tier-vars: Definitions helping to instruct Multi-Tier Blockchain implementation, such as how T2 blockchains are implemented in a geographic location. Other variables include variations on the above variables for each Tier, such as Xmt1 and Xmt2 (variation on Xm—number of blocks between determining latest set of active Validators), Nvt1 and Nvt2 (variation on Nv—Validators proposing new block pairs), Svt1 and Svt2 (variation on Sv—block time), Btt1 and Btt2 (variation on Bt—block size), etc.

Stt: The amount of time a wallet's transactions can be suspended, pending a transfer to a different T2 node in a multi-tier blockchain approach.

Transaction Privacy

Some embodiments of the present invention provide various capabilities through the integration of a trusted entity with a trustless blockchain. Note that the trustless blockchain does not itself have to trust the trusted entity, and the trusted entity need not be trusted by all users of the trustless blockchain. Rather, those users who are comfortable with, or required to, trust the trusted entity can use it to realize certain benefits that are not possible with purely trustless blockchains.

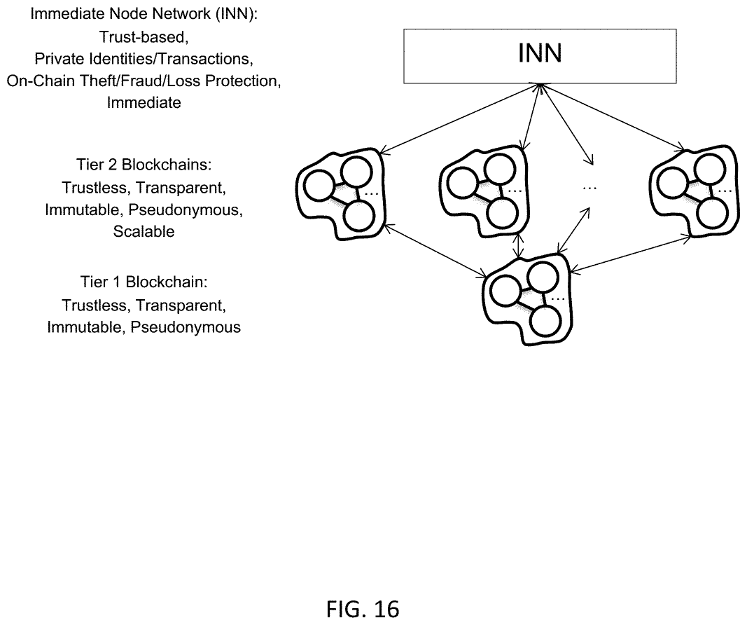

Certain embodiments of the present invention make use of a trust-based network operated by a trusted entity. This network is referred to herein as the Immediate Node Network, or INN, and is illustrated in FIG. 16. It is built on top of the underlying distributed ledger. It allows immediate transactions that can be verified in under one second. It also enables a number of additional features such as fraud and theft protection, loss prevention, a stable version of the cryptocurrency, and private transactions. Details on the utilization of the INN, and features innately tied into embodiments of the present invention, are provided in various sections below. The INN utilizes a secondary form of the blockchain's cryptocurrency called Protected-currency, described below. Protected-currency Wallets and Protected-currency transactions have a known identity associated with them, privately held by T3P, which in turn enables the INN's optional features.

Wallets

Wallets include private and public keypairs, and indicate ownership of Primary-currency. Wallets can be automatically added for accounts on systems that use Primary-currency. Code will be available for individuals to create their own wallets as well.

There are two types of wallets, standard Primary-currency wallets and Protected-currency wallets, which have added protections and which are described below. The system API will include wrappers for other cryptocurrencies, as well. These wrappers will create an interface for interoperability between the system and other blockchains.

Validator Incentives

Validators are rewarded for maintaining consensus. The rewards for Validators are commensurate with the task of running a server, however, and therefore the vast majority, if not all, of new Primary-currency issuances will serve as incentives to the community surrounding the system. It is expected that Validators will be paid out of Primary-currency reserves or in fiat currencies.

The rewards for Validators are based solely off of maintaining consensus and are awarded per block-pair in the case that Primary-currency is part of the incentive. Block rewards are not affected by which Validators are actually proposing and creating blocks. The reward calculation amount can be continually adjusted by a governing entity or organization, referred to herein as GOV. Validators who are active will share in the block rewards irrespective of who proposed the blocks.

Smart Contracts and Smart Coins

Smart contracts can be implemented either as part of the core protocol itself, or in the form of Smart Coins which provide added functionality. Core functionalities that create value for the entire blockchain are implemented in the protocol itself. For example, the definitions of what types of Smart Coins are available and how they are processed is part of the protocol. Capabilities associated with Protected-currency (such as chargebacks and recoveries from theft or loss), lending functionality, and the implementation for immediacy (the Protected-currency Allocation Amount), are also part of the protocol itself. The protocol utilizes Smart Coins for more generic functionalities.

Smart Coins are an important aspect of the protocol. They represent other types of ownership and identity beyond Primary-currency itself as well as implementations for on-chain processing and operations.

There are a number of ownership and operational representations that are maintained with Smart Coins, and any of these representations or operations are associated with a wallet. These Smart Coins can be held in a wallet in the same way that Primary-currency is held in a wallet, and can be transferred in the same way that Primary-currency is transferred on the blockchain. Smart Coins can be issued by the INN (for example, when new Validators are added), or algorithmically by the blockchain (for example, when ownership is created for a new wallet in a multi-tier blockchain approach), or from users in the system. Smart Coins utilize a composition-based programming philosophy in which groupings of Smart Coin elements combine to produce more sophisticated behavior. Examples of Smart Coins are given below.

Smart Coins can have their own transfer rules. For example, the INN can transfer Validator Smart Coins from one account to another. The INN can also transfer Status Smart Coins, ID Smart Coins, or Voting Smart Coins to a wallet, but cannot transfer them out of a wallet. Wallet Smart Coins can only be transferred by a T1 blockchain. Smart Coins can also have special properties, such as rules upon which they are removed from the blockchain state to save space (leaving only their hashed representations in a Merkle tree), whether they are eligible for reversals when sent from a Protected-currency wallet, or other properties required for specialized functionality. Smart Coins can represent fungible or non-fungible digital assets, or can simply be used as part of transfer or ownership mechanisms.

Cryptocurrency Classes

Similar to the addition of Smart Coins into the network, there can be other fungible representations of value separate from Primary-currency itself. Separate classes of cryptocurrencies can be maintained in the blockchain. One example is a separate cryptocurrency simply maintained on the network, but which represents another type of value or ownership. This could be valuable in a similar way that ERC20 coins are used in the Ethereum network. The example system can be partnered with others to have other types of cryptocurrencies included on the blockchain and validated using its techniques.

Protected-Currency

The example system can utilize a specific, secondary type of cryptocurrency class called Protected-currency to enable more protections on transfers. No user is ever required to send a transaction in the form of Protected-currency as it is a completely optional feature of the system; however, the use of Protected-currency can provide valuable protections based on trust of one or more trusted third parties (referred to herein as T3P) (in the same way that people trust credit card companies to protect their interests when making online purchases). An account with T3P is required to use Protected-currency, so that its protections can be verified.

Chargebacks

Protected-currency can be used to handle situations where the ability to have chargebacks or reversed transactions is desired. Protected-currency operates under special rules, different from Primary-currency, but all Protected-currency transactions are validated on the blockchain using the same methodology as Primary-currency. Protected-currency serves as a temporary instrument that represents Primary-currency, but transactions made with Protected-currency can be reversed by T3P. Protected-currency is similar in nature to a particular type of smart contract, but its purpose and use is defined and it is integrated into the core of the protocol.

When a transaction, such as a purchase, is desired to be made with Protected-currency, the sender simply indicates that Protected-currency should be sent instead of Primary-currency. Protected-currency replaces the Primary-currency in the sender's wallet, and Protected-currency is then sent to the recipient. Protected-currency also includes a timestamp indicating when it was sent and a time period upon which it converts back to standard Primary-currency. The system default is Sd seconds (for example, a number of seconds equivalent to 15 days). This conversion is an automatic transaction computed and validated by nodes. During the Sd seconds before Protected-currency becomes Primary-currency, T3P has the authority to reverse the Protected-currency transaction (by adding an inverse transaction). Protected-currency cannot be transferred by a recipient after it is received while still in the form of Protected-currency. At any time while Protected-currency is owned, the recipient can send a message declining the Protected-currency, and it will become Primary-currency in the sender's wallet as if the transaction never happened (which is implemented as a transaction). The sender can also send a message that immediately converts the Protected-currency to Primary-currency for the recipient (for example, when a product has been received in good condition).

In this way, Protected-currency can represent a safer method of transferring value. Customers (senders) can send payments knowing that there are safeguards in place in case a seller (recipient) is acting fraudulently. Disputes are handled through a dispute-resolution process mediated by T3P, similar to credit card disputes. Dispute resolution is based on legal principles such as seller requirements and claims on a platform making a sale.

The Protected-currency time period is automatically incremented when a user indicates suspicion of fraud and initiates a dispute. GOV or T3P can increase the system default value of Sd or further increase a Protected-currency's time period if more time is needed for dispute resolution.

Theft Protection

Special Protected-currency Wallets can be created so that transactions can only be sent using Protected-currency rather than Primary-currency. Protected-currency Wallets must be created through the approval of T3P, so that identity can be verified. Once users have a verified account with T3P, they can create new Protected-currency Wallets as needed. By using Protected-currency Wallets, if a user's private key is stolen, and funds are illegally transferred, the transaction can be reversed. A stolen private key for a wallet can be proven, and then the transactions can be reversed and sent to a newly created Protected-currency Wallet. This makes the risk of theft significantly lower for those who choose to use Protected-currency Wallets. Protected-currency Wallets use the system value of Sd when transfers are made, and the check is made against the timestamp versus Sd, as opposed to a lifetime associated directly with the Protected-currency in this case. Protected-currency Wallets cannot send the message that immediately converts Protected-currency to Primary-currency. Sd can be modified at any point by GOV or T3P.

Lost Private Keys

If a user loses a private key, then the user can request that T3P initiate a transfer from a Protected-currency Wallet into another newly-created Protected-currency Wallet owned by the same user. Similarly, Primary-currency can be transferred to a beneficiary upon a holder's death. As a protection against T3P transferring Protected-currency inappropriately (which we never expect to occur, but which we allow a user-controlled safeguard against as a precaution), a user can transfer the Protected-currency in the form of Primary-currency into a new Primary-currency wallet (using the private key, which in this case was not actually lost), therefore effectively reversing an INN-initiated transfer.

Features

Any transaction out of a Primary-currency wallet can be made by a sender (buyer) in Protected-currency if they have a T3P account. A Protected-currency transaction deducts Primary-currency from the wallet as normal, and the recipient receives Protected-currency rather than Primary-currency. The Protected-currency includes a timestamp on creation and a time period associated with it, upon which it converts to Primary-currency. If a recipient (seller) acts fraudulently, such as by failing to deliver purchased goods, the sender can contact T3P and while the payment is still in the form of Protected-currency, T3P can reverse the transaction.

Protected-currency cannot be transferred from a wallet (other than in the case of the initial conversion from Primary-currency). Protected-currency converts back to Primary-currency automatically at the end of its lifetime. At that point it can no longer be modified by T3P. The sender can set the conversion time period when the Protected-currency is created or use the system default. The recipient can decline the transaction, which returns Primary-currency to the sender's wallet. The sender can send a transaction message (such as when a purchased product has arrived in good condition) converting the Protected-currency to Primary-currency immediately.

Users can elect to keep their Primary-currency in Protected-currency Wallets rather than Primary-currency Wallets. Protected-currency Wallets include added protections against theft and loss. Protected-currency Wallets hold a user's Primary-currency as a normal wallet would, but any outgoing transfers from a Protected-currency Wallet must be in the form of Protected-currency.

The time period for a Protected-currency Wallet transfer can be the system default time. If a user's Protected-currency Wallet private key is stolen and funds are transferred fraudulently, the user can contact T3P, and T3P can reverse the transaction and send the funds into a newly created Protected-currency Wallet with a new private key. If a user loses the wallet's private key, T3P can transfer Protected-currency into a new Protected-currency Wallet. As a protection against T3P transferring Protected-currency inappropriately (which we never expect to occur, but which we allow a user-controlled safeguard against as a precaution), a user transfers the Protected-currency in the form of Primary-currency into a new Primary-currency wallet (using the private key, which in this case was not actually lost), therefore effectively reversing an INN-initiated transfer.

Protected-currency Wallets can be utilized to implement other features like Immediate Transactions, Private Transactions, Identity Verification, and Credit/Loans.

Immediate Transactions

The system can implement transactions immediately through Immediate Nodes on the Immediate Node Network (INN), such as when a transaction is desired to be implemented on credit card rails or a credit card network or when transactions are desired to be immediately approved through a mobile transaction, as examples. Normally, a transaction is received by a standard node, put into a transaction component of a block-pair, and then the validation component of the block-pair will validate the block and therefore the transaction. A deeper block will be more secure as well, though with Proof-of-Validation, even a validated block with priority at the top of the blockchain is relatively secure, particularly with a value of Vp over 50%. This means that a transaction can take the block time, or Sv seconds, before it is validated and approximately 2*Sv seconds before it is one block deep, even on a T2. This amount of time can be too slow for transactions that need to be validated immediately.

Immediate Nodes are used to implement a traditional, trust-based account network. However, Immediate Nodes use an operational procedure directly integrated into the system protocol for both security and a more seamless integration. Primary-currency owners can use a Protected-currency Wallet to indicate an allocated amount, called the Protected-currency Allocation, or Dallocation. The Dallocation sets aside Primary-currency, Crypto-fiat, or other tokens to be verified immediately by the INN. The Dallocation can be utilized for immediate transactions and represents Primary-currency held in the user's wallet that the INN can transfer through its payment channels based on a user's actions (such as a credit card purchase or mobile app purchase). A user can send an encrypted originating message in order to create the Dallocation for a Protected-currency Wallet, along with an indication of the INN's permissions for sending Primary-currency from the Dallocation. For example, INN transactions can be limited in amounts over a given time period. The amount reserved within the Dallocation cannot be transferred out of the Protected-currency Wallet other than through transactions originating from the INN. Those transactions do not utilize the private key for the Protected-currency Wallet, but instead nodes on the INN use their own private keys to create transactions that can be validated by T2's.

T3P can therefore allow the ability to guarantee payments immediately, and can allow the processing of transactions such as Point of Sale credit card transactions through standard credit card machines. A POS purchase can trigger a transaction withdrawing an amount from a Dallocation. The INN maintains records of balances of the Dallocations for each Protected-currency Wallet that has a Dallocation. The INN sends transactions to the T2's, which updates account balances on the blockchains themselves. When Immediate Node payments are no longer desired, an owner can instruct the INN to send a transaction to the network releasing the Dallocation into standard Primary-currency amounts within the Protected-currency Wallet. Since Dallocations are in Protected-currency Wallets, theft originating from a hack of the INN would be preventable. Fraudulent transactions from the INN can be reversed since Dallocations are held in Protected-currency Wallets. Overall, this approach allows the INN to guarantee a payment, and the guarantee can be instant.

The INN can consolidate transactions over time before submitting them to the actual blockchain. For example, if Wallet A sends 100 Primary-currency to Wallet B, and Wallet B sends 100 Primary-currency to Wallet C, the INN can send a message to the Network that a transaction of 100 Primary-currency was sent from Wallet A to Wallet C. It can summarize state information within its node accounts before synchronizing with the Network.

Stability

The protocol has the ability to ensure stability through a concept called Crypto-fiat, a non-volatile one-to-one fiat backed representation of Primary-currency. This is accomplished through the use of the Dallocation. Amounts that are transferred into a Dallocation by a user can be converted through an exchange mechanism into Crypto-fiat. Crypto-fiat can take a number of forms such as Crypto-dollars or Crypto-euros, for example. For every Crypto-dollar that is issued by T3P, as an example, one US Dollar will be put into an escrow account controlled by T3P. The escrow account will be audited, and can be publicly verified as to its integrity from the beginning. Those Crypto-dollars can be transferred within the blockchain for purchases, through Dallocation mechanics. At any point in the future any Crypto-dollar holder can receive a US Dollar out of escrow from T3P in exchange for the Crypto-dollar (which is then destroyed). In this way there are always exactly as many US Dollars in escrow as there are Crypto-dollars in existence, so the price of Crypto-dollars will not be volatile and will track very closely to the value of US Dollars (or Crypto-euros to Euros, etc). Crypto-fiat contained in Dallocation portions of accounts can only be transferred by T3P, and T3P collects fees on Dallocation transfers. However, if users want to transfer cryptocurrency to other users without any fees, they can do so by exchanging Crypto-fiat with Primary-currency, which can then be exchanged back to Crypto-fiat by the recipient. Fundamentally the Dallocation and the Crypto-fiat implementation of Primary-currency allow stable transfers of cryptocurrency, and create a practical way to use cryptocurrency for more than just a store of value. Crypto-fiat is used with the protocol's other features such as fraud, theft, and loss protections, or the implementation of privacy.

Crypto-fiat can also be used to wrap other assets. A Dallocation can contain Crypto-bitcoin, Crypto-ether, or even Crypto-gold. A Dallocation can also contain Crypto-baskets that represent groupings of fiat currencies and other financial instruments which can have even less volatility than the US Dollar.

The ramifications of Crypto-fiat are significant. With a stable cryptocurrency, many things are possible that otherwise would not be. For example, if a cryptocurrency's value is going up, buyers do not want to use it for purchases. If a cryptocurrency's value is going down, sellers do not want to accept it for sales. Loans or credit will have high default rates when a cryptocurrency's value is going up, and lenders will not want to lend with high volatility in either direction. High volatility prevents the use of cryptocurrency in many practical situations, but with a stable version of Primary-currency, it can actually be used for these purposes. Online payments, retail purchases, lending, credit, and foreign exchange all become feasible with Crypto-fiat, and all of the other benefits of a cryptocurrency then become much more powerful.

Digital Credit and Loans

T3P can provide digital credit (i.e. the equivalent of a digital credit card or a loan) with a Credit Smart Coin or a Loan Smart Coin. Transactions are automatically processed from the account holding the Credit Smart Coin or Loan Smart Coin to pay off the balance. These Smart Coins include all parameters associated with loans/credit, such as balance, interest rate, term, payment terms, compliance and status, etc. Balances are updated automatically based on these parameters (in essence, they operate like a specialized smart contract, with the limited calculation related to the loan's status). Credit Smart Coins and Loan Smart Coins cannot be transferred, of course, except by the loan holder. Credit Smart Coins include an available balance like a standard credit card. Loan Smart Coins disappear when they are paid off. Primary-currency received on credit can be used with the Dallocation described above to enable immediate payments. In this combination, credit can be implemented like a traditional credit card. Credit and lending is a particularly valuable concept when combined with Crypto-fiat.

Privacy

A disadvantage of most blockchain approaches is a lack of privacy, since the blockchain relies on all information being publicly available (though encrypted) to obviate the mutual trust required in transactions that are not publicly auditable. The example system has a publicly available blockchain that provides pseudonymous privacy. From a purely technological standpoint, an account/wallet can be held without having any identity associated with it. However, anyone can track where amounts go and the current balance of any wallet like most blockchains. In many legitimate and legal situations, a higher level of privacy is needed. For example, one might wish to keep their wallet balance private, if they can be associated with the wallet. It is common that people do not want to publicly announce their bank account balances. Association between an identity and a wallet can happen over time by combining real-world information with on-chain events, as examples by correlating timing of known purchases or amounts of known purchases with individuals. E.g., mortgage payments, large purchases, or even small purchases such as fuel for an automobile or subway tickets can be used to match a particular wallet with an observed individual. Also, for voting purposes, it is often desired to separate one's vote from one's identity. In many cases, even a vote that is associated pseudonymously can be undesirable. One might not want their vote to be able to later be traced back to them.

One approach to solving the privacy issue is to employ a mathematical solution that prevents visibility on transactions, and makes transactions truly anonymous. An example of this is the ZCash protocol which uses zero knowledge SNARKS in which transactions are encrypted, but the blockchain still assures no double spending. For the principles described herein, however, this is not a preferred solution. First, a large part of the system's philosophy is built around transparency. Since Validators are permissioned, the protection of all users relies on full transparency of the code being used, the rules for the governing foundation, and, for our purposes here, the blockchain itself. A blockchain that can be easily audited in the most transparent way fits the spirit of the example system. Second, another of the desired principles is to build a practical solution that can evolve as regulations evolve. A true zero-knowledge approach is difficult to reconcile with Know-Your-Customer (KYC) and Anti-Money-Laundering (AML) rules. We believe that a KYC and AML friendly approach is most likely to thrive and grow as government regulations evolve.

All of that said, privacy is important to many users. The present invention's approach to privacy allows an optional methodology for implementing private transactions in cases where it is desired. Our approach uses a trust-based methodology implemented via the INN. In order to send a private transaction, first a user sends Protected-currency to a privacy account owned by T3P from a Protected-currency Wallet. Then the user sends an off-chain message to the INN, encrypted both in terms of the transmission itself and using the wallet's private key to encrypt the transaction, instructing where that transaction should be sent. The INN can validate the transmission against the amount received using the wallet's public key, and then send a transaction message to the network implementing the transaction. A user can transfer money anonymously in this way. However, for KYC and AML purposes, it should be noted that T3P will know the identity of the sender, as Protected-currency Wallets (where the ID is known to T3P) are used for these private transmissions. The amounts sent can be instructed to happen over a time period to one or more wallets in one or more amounts so that public tracking by amount can be obfuscated. Transactions, which are in the form of Protected-currency, that are reversed by the INN must be routed back through the INN, as the public sender for the Protected-currency will be an INN wallet on the blockchain. A reversal received by the INN must reference internal private records to send the Primary-currency back to the original wallet. The INN is the only entity on the blockchain which can send outgoing Protected-currency or Primary-currency amounts based on a transfer from incoming Protected-currency amounts.

This approach can be used in a number of situations. A single transfer can be made privately, where the amount sent cannot be publicly tracked to the destination. Primary-currency owners can privately send amounts to other wallets they own to maintain privacy on the accounts they own, particularly if an account's identity was determined. This can also be done to further obfuscate a transaction from being reverse-engineered. For example, a private transaction can have Protected-currency sent to a recipient address and any remaining Primary-currency can be sent to different wallets the sender owns. Private voting can be implemented, where a Vote Smart Coin can be transferred (i.e. a vote cast) privately through the private transmission to the INN, which in turn transfers the Smart Coin to the correct voting account with the correct weighting, consolidated with other votes so that votes cannot be traced back to the original holders. Votes can include an encrypted message that only the sender can decrypt, to later verify that a vote was cast appropriately. In this way users can vote, as well as verify that their votes were correctly placed, but only they know that their votes originated from them.

If both privacy and immediacy are desired (i.e. a transaction analogous to a credit card transaction), the user can instruct that each transaction indicated as a Dallocation transaction will move remaining balances in the wallet into a new Protected-currency Wallet. The Dallocation in the new wallet can be adjusted by the INN, amounts can be sent to multiple wallets, or amounts can be sent over time in multiple transactions, in order to obfuscate public determination of the transaction. The user can track their balances and wallets through an INN account. Alternatively, an INN account can also receive Primary-currency that can be transferred with both privacy and immediacy, but which never is reflected on the blockchain itself, such as is often done on exchanges. Protected-currency accounts created algorithmically by the INN will retain ownership records matching the owner so that private ownership knowledge is maintained.

The INN can consolidate many transactions and post summaries to the blockchain at intervals, further aiding with privacy and efficiency. The intervals upon which the blockchain is synchronized will not affect the immediacy of transactions. Transactions and balances can even be held entirely off chain, with internal tracking by the INN in wallets associated with T3P.

Example Summary of Transaction Categories

The following categories indicate how a sender can implement a transaction. All of the categories of transactions other than Primary-currency itself are optional, and are used by a Primary-currency owner only when added functionality or safety is desired. A user can determine whether Protected-currency or Protected-currency Wallets are to be used, and whether the INN is involved in any given transaction.

| | | | Protection | Protection from | | |
|---|---|---|---|---|---|---|
| | Trustless | Reversible | from Fraud | Theft/Loss | Immediate | Private |
| Primary-currency | YES | NO | NO | NO | NO | NO |
| Protected- | YES | YES | YES | NO | NO | NO |
| currency | | | | | | |
| Transaction | | | | | | |
| Protected- | YES | YES | YES | YES | NO | NO |
| currency Wallet | | | | | | |
| Protected- | NO | YES | YES | YES | YES | Partial |
| currency/INN w/ | | | | | | |
| Dallocation | | | | | | |
| Protected- | NO | YES | YES | YES | YES | YES |
| currency to INN | | | | | | |
| w/off-chain | | | | | | |
| instructions | | | | | | |

In terms of User Interface, the options can be set up in a straightforward manner. The standard software or any app that allows transfers of Primary-currency can have a straightforward checkbox with a Protected-currency option for sending any given transaction, and a standard “info” icon to provide information on using Protected-currency.

Similarly, when wallets are created with Primary-currency software, the alternative Protected-currency Wallet can be described, with a link to T3P page for creating Protected-currency Wallets. When creating Protected-currency Wallets, immediacy and privacy options can be described as options. The underlying implementation does not need to be detailed to users. The choices and ramifications in setting up different types of wallets and implementing different types of transactions will be described in a straightforward way.

Operation of the Trusted Entity and the Immediate Node Network

GOV is an entity that oversees the operations of the network to assure consensus. The Immediate Node Network (INN) is controlled by GOV and is used to oversee consensus operations and add optional features. It is founded on a system of transparency—the rules that GOV operates under to oversee consensus are available at any time to anyone, all algorithmic operations of the network are available at any time to anyone, and all results of those algorithmic operations (i.e. the blockchain itself) are available at any time to anyone.

Lending System

T3P provides a mechanism for lending with fixed-supply, protected, fractional reserve lending. Having the ability to borrow Primary-currency can be a very valuable functionality for our community. In order to allow lending and borrowing, the protocol utilizes Lending Coins, Loan Coins, and on-chain contractual mechanisms based on those coins, which together create a lending system that shares some of the same characteristics and benefits of fractional reserve banking. However, in contrast, the example system addresses the weaknesses of fractional reserve banking. The example system's protocol has a specific limit on the amount of Primary-currency that can be issued. A pre-determined portion of lending capability is set aside for T3P, called the Primary-currency Loan Reserve (DLR), in order to guarantee the majority of any given withdrawal (80%) for any given depositor. Lenders can only make loans in an aggregate total amount equal to the DLR, given loan issuance rules controlled by Lending Coins. Because loans cannot be made in aggregate beyond the DLR, the lending system is non-inflationary (as it relates to monetary supply) beyond the DLR, and the overall fixed supply of Primary-currency cannot be adjusted more than the DLR. All of the algorithms that define lending mechanisms are implemented automatically by nodes.

In order to implement lending, Lending Coins are issued by T3P. A wallet that contains a Lending Coin can be considered to be a lender. These Lending Coins can be sold by T3P so that a lender has a basis in its activities, or T3P can require a deposit. T3P can also agree to repurchase a Lending Coin, for example, using a fiat currency or Primary-currency, or by returning a deposit. Details are negotiated between T3P and lenders. In order to create a lender, T3P sends a Lending Coin to the lender's wallet indicating both the amount it can lend out to others and the lender's obligations. There are two types of Lending Coins—Fractional Reserve Lending Coins and Full Reserve Lending Coins. Lending Coins record lending authorizations, and Fractional Reserve Lending Coins can only be issued up to an aggregate amount equal to the DLR. Full Reserve Lending Coins do not add to that aggregate amount. If T3P tries to authorize lending in an aggregate amount of Fractional Reserve Lending Coins larger than the DLR, that issuance transmission will be considered invalid by nodes (e.g., computers) in the system.

Fractional Reserve Lending Coins.

After a fractional reserve lender is created with a Fractional Reserve Lending Coin, it can accept deposits. T3P cannot deposit Primary-currency into lender's accounts. When a lender accepts deposits, a liability is created where the lender has an obligation to return deposits when the depositor requests a withdrawal. After lenders have received deposits, they can make loans to others. Lenders can only loan up to 80% of their deposits, and must maintain 20% of their total outstanding deposits as a Primary-currency reserve. At the end of any given period, if the 20% balance is not maintained, then the lender must borrow money from T3P at a rate defined by the Lending Coin. This will happen automatically on the blockchain. Lenders have an obligation to immediately return 80% of deposits when a withdrawal is requested, and lenders cannot perform any further lending until they have returned the remaining 20% of a withdrawal request. In order to return the final 20% of a withdrawal request, a lender must maintain additional reserve (beyond the 20% reserve) to account for the 20% risk on that withdrawn deposit to maintain the same 20% risk level for other depositors and T3P. When a lender makes a loan, it issues a Loan Coin that defines standard loan terms like interest rate, term, and payment obligations. The lender also issues Primary-currency that the borrower can use. If a depositor wants to make a withdrawal and the lender does not have enough money in its reserve to cover the withdrawal, then the lender must borrow money from T3P to cover the withdrawal. Because 80% of the fractional reserve for all lenders is guaranteed by T3P for withdrawals, and depositors can only demand a withdrawal of 80% of their balances, there is no risk of a lender defaulting on its obligations, even if everyone requests all of their money at once (known in the banking industry as a “bank run”). Because depositors have a 20% risk on their deposits, there is an incentive for lender scrutiny when making deposits. Additionally, Lending Coins can allow voting rights to depositors to approve loans.

Full Reserve Lending Coins

A Full Reserve Lending Coin can be issued by T3P to a wallet that contains Primary-currency to cover any lending. When the Full Reserve Lending Coin is issued with a lending limit, an equal amount of Primary-currency in the wallet is locked to the loan, and cannot be transferred other than through a loan. If there are no outstanding loans, the lender can remove the Full Reserve Lending Coin, freeing the locked Primary-currency. The Primary-currency that is locked can be loaned to others within requirements set by the Full Reserve Lending Coin. The lender assumes all risk for bad debt on loans with a Full Reserve Lending Coin. T3P receives a percent of interest profits, defined by the Lending Coin, on full reserve loans.

Lending

Borrowers receive Primary-currency and Loan Coins representing their debt. Loans are automatically repaid in defined installments described by the Loan Coin in the wallet. Primary-currency amounts in the wallet are automatically applied to loan payments. If a wallet does not contain enough Primary-currency when a loan payment is due, the loan is immediately considered in default, and penalties can be applied to the loan's balance, as defined by the Loan Coin. If the loan is in default for too long a time period or in too high an amount, as defined by the Loan Coin, then the lender has the option to foreclose on the loan. Loan Coin terms must fit within interest rate and other obligations defined by the issuing lender's Lending Coin. Lending Coins must fit within overall lending requirements defined by T3P's bylaws. T3P negotiates the requirements on lending when issuing a Lending Coin, within bylaw limitations.

When a loan is repaid, the principal credits any loans from T3P first and then adds to the lender's reserve second. Interest on the loan is shared between participants as profit. Interest goes 40% to the lender's depositors (pro-rated over all deposit lifetimes during the relevant term of the payment), 50% to the lender, and 10% to T3P. If a loan is not repaid, then the lender must satisfy the outstanding debt by foreclosing on collateral (on or off chain) or by using profits on other loans. Ultimately if the lender itself defaults and goes bankrupt, T3P will guarantee 80% of the deposits out of the DLR, and the Lending Coin in question becomes frozen. Because depositors are in a position to lose 20% of their deposit in the case of loan default, they are incentivized to choose a trustworthy lender. When a Lending Coin is frozen, it still counts towards the aggregate amount that can be loaned with respect to the DLR, but no further lending can occur with that Lending Coin until T3P repays the bad debt associated with it. Therefore, frozen Lending Coins lower the total amount of Primary-currency available to be loaned, until T3P pays off bad debt associated with frozen Lending Coins.

Credit

T3P can issue credit in the form of Credit Coins from available amounts in the DLR or from Primary-currency ownership, directly to users. Credit Coins act in a similar fashion as credit cards. Where a Loan Coin disappears when a loan is paid off, a Credit Coin can be used for credit on an ongoing basis, subject to the terms associated with its use.

DLR Availability

The DLR can unlock, and be available for lending purposes, over time. e.g., 20% will unlock one year after launch, and an additional 20% will unlock each year thereafter until the full DLR is available for lending.

Identity

Identity is a powerful solution within the example protocol. Smart Coins can be issued by the INN in order for users to prove their identity in a variety of use cases. Identity Smart Coins are issued to Protected-currency wallets only, as T3P knows the identity of Protected-currency wallet holders by definition.

Identity Smart Coins can be used in any situation where an identity is required for a transaction, such as a seller that wants to validate an identity for a sale. In this case, the INN can issue an Identity Smart Coin to a Protected-currency Wallet with Primary-currency for the transaction. It is important to note that the identity of the individual does not need to be associated with his/her entire Primary-currency ownership. A Primary-currency owner can create a new Protected-currency Wallet on a case-by-case basis, send Primary-currency to that wallet or receive Primary-currency from someone else, and then request that the INN issue an Identity Smart Coin for the new account. The transfer of Primary-currency to a new Protected-currency Wallet can additionally be handled via a private transaction, described below, so that an Identity Smart Coin cannot be publicly linked with other accounts.

Identity Smart Coins can be encrypted, so that the intended recipient is the only entity that can validate and use the identity. For example, a third-party partner can put a relationship in place with T3P to utilize its identity-validation techniques. The INN can encrypt identities to be decrypted later by the third-party using a provided decryption key. Alternatively, the owner can request an Identity Smart Coin encrypted with a key that the owner holds. The INN can send Identity Smart Coins to wallets upon their owners' requests. Then, transactions originating from an identified Protected-currency Wallet, whether these transactions involve Primary-currency or not, can be verified as originating from a specified identity, using the Identity Smart Coin that the INN sent. Identities can also be verified by T3P with the owner's prior approval. Identity Smart Coin encryptions include numerical aspects of the wallet, such as its public key, so that Identity Smart Coins sent by the INN cannot be associated with unrelated accounts using public records.

As another example of Identity Smart Coin use, T3P can verify the citizenship status of a Protected-currency Wallet owner. This can be initially done by T3P through standard means, such as by obtaining a copy of a passport. The owner can then request that an encrypted Identity Smart Coin be sent to their wallet, including their name and citizenship information, to be used with a service that is only available to citizens of a particular country. The owner could then send a Primary-currency payment to the service provider. The service provider can either decrypt the identity (if that was arranged ahead of time with T3P), or the service provider can request a validation of the ID from T3P, which can provide it with the owner's permission (either as an account setting or as part of the original Primary-currency transmission), or the owner can provide the key to be used to decrypt the identity with an off-chain message.

Identity validation can have many useful purposes. It can be used to enable voting by a third party. It can be used in transactions that require some level of identification such as joining an organization, securing a credit card or mortgage, making a purchase, taking an action restricted to certain groups, participating in a raffle, or interacting with an online group.

Identity Smart Coins can include personal details, such as name, address, email, phone number, gender, nationality, or any other information needed in an identity request. T3P can also aid in identity validation by overseeing other types of identity inputs such as a bank account validation (sending small amounts that are reported back), mobile phone texting validation, validation of government issued IDs or reference numbers, physical facial or fingerprint scans, or any other type of identification information that can lend itself to a digital identity. Identity Smart Coins can be used with third-party systems, such as for submitting a request. An Identity Smart Coin can be used to apply for a membership, where all of the details needed for the application can be included in the Identity Smart Coin, and the transmission of an Identity Smart Coin is the act of applying for the membership.

Below is a list of example use cases. These can be implemented with third parties that establish a relationship with T3P, or they can be implemented via an encryption key that the owner provides separately. T3P can accommodate various implementations based on the user's instructions.

Voting—The INN can issue encrypted Identity Smart Coins to accounts that are eligible for a vote, and those Smart Coins can be sent to the third party's addresses representing voting choices (either through a private or public transmission). In this way, a single vote per identity can be assured.

Memberships—The INN can issue encrypted Identity Smart Coins to eligible members with all of the information required to apply for a membership. The user can send the Identity Smart Coin to the third party's address to apply for the membership. If there are membership fees, those fees can be paid in Primary-currency from the account holding the Identity Smart Coin. A membership can be associated with a physical location like a gym or club, or it can be for online activities like a video game or social site. Identity Smart Coins could be used to verify gender in an online dating site, or age for COPA (Child Online Protection Act) purposes in gaming or other websites.

Raffles—The INN can issue encrypted Identity Smart Coins to eligible participants in a marketing event such as a raffle. Users can self-identify whether they are willing to accept marketing Smart Coins (marketing Smart Coins can also include Primary-currency to incentivize participation, for example). The Identity Smart Coins can assure fair participation.

Obtaining a Credit Card—The INN can issue an encrypted Identity Smart Coin not only including identity information for obtaining the account, but information needed in order to verify a credit score. Alternatively, a pre-paid credit card can be applied for using Primary-currency funds in the user's account. The transmission transferring the Identity Smart Coin to the issuer account represents the application. Applications can of course be submitted for other similar instruments implemented on-chain, like loans (implemented with a Loan Smart Coin) or off-chain like mortgages (implemented through external contracts once the submission is approved).

Restricted Purchases—The INN can issue an Identity Smart Coin to a user upon the user's request so that a restricted purchase can be implemented. The purchase can itself be made in Primary-currency, and the ID Smart Coin can validate requirements for the purchase, such as an age requirement for buying alcohol or securing a senior citizen discount, a gender requirement for buying a ticket to a dating event, a group requirement like a military or educational discount, a location requirement like citizenship, or any other kind of identity validation.

Crypto-Fiat Examples

The following examples show uses of Crypto-fiat, a one to one backed version of Primary-currency which are maintained in Protected-currency Allocation Amounts (Dallocation) in the blockchain. These examples show conceptually how Crypto-fiat can be utilized, but specific implementations will vary in the future as it is fully developed. There are many other types of uses for Crypto-fiat, beyond the examples given here, as well.

Primary-currency owner who wants Crypto-dollars: Mike has Primary-currency that he wants to convert into Crypto-dollars to be able to spend at locations that accept Primary-currency. His Primary-currency is worth $500 at current exchange rates. Joe wants to buy some Primary-currency. Joe purchases the Primary-currency from T3P for $500 (to keep it simple it's just Joe in this example, but these trades could occur with multiple buyers and sellers of course). T3P puts the $500 in escrow, and issues to Mike 500 Crypto-dollars. T3P now has $500 in escrow, Joe has the Primary-currency, and Mike has 500 Crypto-dollars. Mike can spend his 500 Crypto-dollars through T3P′s payment channels, such as a Primary-currency app.

Business that wants to accept Crypto-dollars: A restaurant chain wants to accept Crypto-dollars at its restaurants. T3P puts an agreement in place with the chain, and charges a small fee on transactions, though it is a smaller fee than they typically are charged for credit card transactions, for example. T3P provides easy to implement access to its Dallocation payment system. When purchases are made, T3P can immediately verify and approve them, and then all Crypto-dollar transactions need to be sent by T3P to the blockchain. End users (customers at the restaurant) do not see any additional cost, similar to credit card payments. Once the chain has Crypto-dollar revenue, the Crypto-dollars can later be exchanged for USD out of T3P's escrow. At the end of the month the restaurant chain will owe T3P payments on fees. Those fees can be paid in Primary-currency, adding to its liquidity.

Customer who wants Crypto-dollars: Sally wants to spend Crypto-dollars at the restaurant chain given the convenience and safety of Crypto-dollars. Sally creates a wallet, creates an account with T3P, and then purchases 100 Crypto-dollars with $100 USD. T3P then adds 100 Crypto-dollars into Sally's wallet, allocated in the Dallocation, and puts the $100 USD into an escrow account. She can now spend her Crypto-dollars using T3P's app, or a debit card as examples. She walks up to the counter, orders her food, and then makes a payment for $10.22, paid with Crypto-dollars. T3P immediately validates the transaction, and then initiates the transfer on the blockchain to the restaurant chain's Dallocation account. A short while later (after the Protected-currency waiting period) the restaurant chain can exchange the 10.22 Crypto-dollars into $10.22 with T3P.

Crypto-dollar owner who wants to convert to Primary-currency to buy something on Craig's list with no fees: Sally then decides she wants to have direct access to transfer her Crypto-dollars as she chooses, and wants to convert her remaining 90 Crypto-dollars to Primary-currency so that she can transfer a larger sum without fees for a purchase on Craig's List. She indicates to T3P's exchange that she wants to convert her Crypto-dollars to Primary-currency. Ron indicates on the exchange that he wants to sell his Primary-currency. T3P transfers Ron's Primary-currency to Sally (with the amount determined by the current exchange rate), removes her Crypto-dollars, and pays Ron $90 out of escrow. Sally then makes the Craig's list purchase by sending her Primary-currency directly to the Craig's list seller's Primary-currency wallet.

Person sending money to relative in another country: Bob wants to send money to Alice, his sister, who now lives in the Netherlands. Bob buys $500 Crypto-dollars from T3P, converts them to Primary-currency on the exchange, sends them to Alice, and Alice converts them to Crypto-euros on the exchange. There is a small fee for the conversion from Primary-currency to Crypto-euros, but the fee is significantly less than a wire transfer fee, and it happens instantly, securely, and in a way that can be easily and conveniently tracked.

A group of friends chipping in for dinner: 5 friends go out to dinner at a restaurant for a birthday celebration for a 6th friend, who they want to take out. The restaurant accepts Primary-currency/Crypto-fiat. At the end of the night the 5 friends open their Primary-currency apps, scan a QR code the waiter brings them, and each easily puts their share into the total payment.

Roommates splitting rent: Three roommates want to pay their shared rent. Two of them transfer Primary-currency to the third with no fees. The third converts the Primary-currency to US dollars, and pays the rent for them. The next month the apartment complex begins to accept Crypto-dollars as a payment. All three then pay their share of the rent directly with Crypto-dollars.

An efficient bank: Banks can implement banking transactions using Crypto-fiat in a regulated fractional reserve implementation, or credit can be implemented with Crypto-fiat. Crypto-fiat can be combined with credit or Lending Smart Coins. This is particularly compelling with the 60% of the world that doesn't have access to banking.

Person with money in a volatile country: Jose lives in a country that is starting to have hyperinflation. Jose and the people around him simply use Primary-currency for their transactions.

Person worried about inflation, economic decline, etc: Nicole lives in a stable country, but it is going into a recession. She buys Crypto-dollars and converts them into either Primary-currency (depending on its stability over time), or Crypto-worldcoin (through Primary-currency as an intermediary), which is a basket of monetary instruments that includes fiat from a variety of countries, and other relatively stable assets like gold.

A bank wanting an inexpensive way to transfer fiat: A bank can use our system to inexpensively transfer inter-bank payments.

A person wanting to sell Primary-currency: Anyone who wants liquidity in Primary-currency can sell it in and exchange, given the liquidity driven by Primary-currency's general use as a cryptocurrency, its use in paying fees for Crypto-fiat, and its use in digital marketplaces including developer stores.

Users sending other cryptocurrencies: T3P can accept other cryptocurrencies and put them into one-to-one backed escrow account in the same way that Crypto-fiat is implemented. For example, users wanting to transact in Bitcoin but without large delays and fees can send Bitcoin to the INN, receive Crypto-bitcoin in exchange, and then transact the Crypto-bitcoin on the network. At any point Crypto-bitcoin owners can exchange their Crypto-bitcoin for Bitcoin out of escrow.

Combating Fraud, Theft, and Loss

Implementation. Methods and apparatuses according to the present invention can be implemented using multiple computers connected in a distributed network. Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of a special-purpose computer, programmable data processing apparatus, processor, processor architecture, and so on.

It will be understood that a computer can include a computer-readable storage medium and that this medium can be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the systems as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) can be utilized. The computer readable medium can be a computer readable signal medium or a computer readable storage medium. A computer readable storage medium can be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium can be any tangible medium that can contain, or store a program for use by or in connection with an instruction execution system, apparatus, or device.

According to an embodiment of the present invention, a data store can be comprised of one or more of a database, file storage system, relational data storage system or any other data system or structure configured to store data, preferably in a relational manner. In an embodiment of the present invention, the data store can be a relational database, working in conjunction with a relational database management system (RDBMS) for receiving, processing and storing data. In an embodiment, the data store can comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium can include a propagated data signal with computer readable program code embodied therein, for example, in baseband or as part of a carrier wave. Such a propagated signal can take any of a variety of forms, including, but not limited to, electro-magnetic, optical, or any suitable combination thereof. A computer readable signal medium can be any computer readable medium that is not a computer readable storage medium and that can communicate, propagate, or transport a program for use by or in connection with an instruction execution system, apparatus, or device.

Program code embodied on a computer readable medium can be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof can be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions can include computer executable code. A variety of languages for expressing computer program instructions are possible, including without limitation C, C++, Java, JavaScript, assembly language, Lisp, HTML, Perl, and so on. Such languages can include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads can be processed more or less simultaneously to enhance utilization of the processor and to facilitate substantially simultaneous functions. By way of implementation, any and all methods, program codes, program instructions, and the like described herein can be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. It is possible to modify or customize general-purpose systems to be used with programs in accordance with the teachings herein, or it might prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages can be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware specialized through computer instructions; and so on—any and all of which can be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations can depict a step, or group of steps, of a computer-implemented method. Further, each step can contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

The functions, systems and methods herein described can be utilized and presented in a multitude of languages. Individual systems can be presented in one or more languages and the language can be changed with ease at any point in the process or methods described above. One of ordinary skill in the art would appreciate that there are numerous languages the system could be provided in, and embodiments of the present invention are contemplated for use with any language.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

We claim:

1. A method of recording transactions using a distributed database over a first distributed network of computers, a second distributed network of computers, and a third distributed network of computers, comprising:
(a) recording a second set of transactions in a second distributed ledger maintained by the second distributed network of computers;
(b) recording a third set of transactions in a third distributed ledger maintained by the third distributed network of computers;
(c) recording entries that correspond to transactions in blocks in the second and third distributed ledgers in a first distributed ledger maintained by the first distributed network of computers;
(d) recording entries that correspond to blocks in the first distributed ledger in the second and third distributed ledgers.

2. The method of claim 1, wherein the first, second, and third networks have at least some computers that are located at physically different sites.

3. The method of claim 1, wherein the first distributed network of computers comprises computers located within 50 miles of each other.

4. The method of claim 1, wherein the second distributed ledger has associated with it a second plurality of wallets, and wherein transactions that are between wallets in the second plurality are recorded on the second distributed ledger and not recorded on the first distributed ledger.

5. The method of claim 1, wherein the second distributed ledger has associated with it a second plurality of wallets, and (a) transactions that remove an asset from a wallet in the second plurality and assign the asset to a wallet not in the second plurality are recorded on the second distributed ledger, and then recorded on the first distributed ledger; or (b) transactions that remove an asset from a wallet not in the second plurality and assign the asset to a wallet in the second plurality, are recorded on the second distributed ledger, and then recorded on the first distributed ledger; or (c) both of the preceding.

6. The method of claim 1, wherein the second distributed ledger has associated with it a second plurality of wallets, and the third distributed ledger has associated with it a third plurality of wallets, and wherein transactions that remove an asset from a wallet in the second plurality and assign the asset to a wallet in the third plurality are recorded on the second distributed ledger, and then recorded on the first distributed ledger, and then recorded on the third distributed ledger.

7. The method of claim 1, wherein the second distributed ledger has associated with it a second plurality of wallets, and the third distributed ledger has associated with it a third plurality of wallets, and the first and second plurality of wallets are distinct.

8. The method of claim 7, wherein there is no wallet that is in both the second and third pluralities of wallets.

9. The method of claim 8, further comprising associating with each wallet an indication of whether the wallet is in the second or third plurality.

10. The method of claim 9, wherein the wallet/distributed ledger association is maintained in a database, and wherein the indication can be changed in the database.

11. The method of claim 1, wherein step (c) comprises determining a consolidated representation of transactions in one or more blocks in the second distributed ledger and recording that consolidated representation in the first distributed ledger.

12. The method of claim 11, wherein the consolidated representation is authenticated as a valid block in the second distributed ledger and cryptographically secured before recording on the first distributed ledger.

13. The method of claim 1, wherein step (d) comprises determining one or more transactions in the first distributed ledger to record on the second distributed ledger, and then recording those transactions on the second distributed ledger.

14. The method of claim 13, wherein the second distributed ledger has associated with it a plurality of wallets, and wherein the transactions determined to record on the second distributed ledger comprise transactions with a recipient wallet associated with the second distributed ledger.

15. The method of claim 1, wherein step (c) comprises arranging a second entry such that transactions to later be recorded on the second distributed ledger are grouped in the recording of the second entry on the first distributed ledger.

16. The method of 15, wherein step (c) comprises arranging a third entry such that transactions to later be recorded on the third distributed ledger are grouped in the recording of the third entry on the first distributed ledger.

17. The method of claim 1, wherein the first distributed ledger has recorded on it sufficient information to determine all the asset transfers recorded on the second and third distributed ledgers.

18. A method of recording transactions on a first distributed ledger implemented on a distributed database using a distributed network of computers, wherein the first distributed ledger has a plurality of wallets associated with it, comprising:
(a) determining if a candidate transaction originates from a wallet that is associated with the first distributed ledger, and, if so, recording the transaction on the first distributed ledger;
(b) determining if a candidate transaction indicates an asset transfer from an originating wallet that is associated with a second distributed ledger to a recipient wallet that is associated with the first distributed ledger, and if the candidate transaction is authenticated by an authenticating entity associated with the second distributed ledger, then recording the transaction on the first distributed ledger.

19. A method of recording transactions using a T1 distributed ledger in a distributed database over a first distributed network of computers, and a plurality of T2 distributed ledgers each in a distributed database over a corresponding distributed network of computers, wherein each T2 distributed ledger has associated with it a corresponding plurality of wallets that are not also associated with any other T2 distributed ledger, comprising:
(a) recording transactions identifying an originating wallet in the T2 distributed ledger associated with the originating wallet;
(b) for any transactions that identify a recipient wallet that is not associated with the same T2 distributed ledger as the originating wallet, after recording the transaction in the associated T2 distributed ledger then recording the transaction in the T1 distributed ledger, and then recording the transaction in the T2 distributed ledger associated with the recipient wallet.

20. The method of claim 19, wherein recording the transaction in the T1 distributed ledger comprises recording a subset of the transaction, which subset includes the asset.

21. The method of claim 19, wherein (a) recording the transaction in the T1 distributed ledger comprises waiting until the recording of the transaction in the T2 distributed ledger is immutable, then recording the transaction in the T1 distributed ledger; or (b) recording the transaction in the T2 distributed ledger associated with the recipient wallet comprises waiting until the recording of the transaction in the T1 distributed ledger is immutable, then recording the transaction in the T2 distributed ledger; or (c) both of the preceding.

22. The method of claim 1, wherein the second set of transactions comprises a first transaction from an originator to a recipient, and a second transaction from the recipient to the originator, wherein recording a second set of transactions on the second distributed ledger comprises:
(a) recording on the second distributed ledger the first transaction, including an indicator of a closing condition for the first transaction;
(b) before the closing condition occurs, recording on the second distributed ledger a second transaction from the recipient to the originator that is at least partly an inverse of the first transaction without requiring cryptographic authentication from the recipient.

23. The method of claim 1, wherein the second set of transactions corresponds to a primary transaction implementing a transfer of an asset from an originator to a recipient using a third party, wherein recording a second set of transactions on the second distributed ledger comprises:
(a) recording at the third party information relative to the originator that allows determination of the identity of the originator;
(b) recording on the second distributed ledger a transfer of the asset from the originator to the third party and verifying that said transfer has been recorded on the second distributed ledger;
(c) communicating from the originator to the third party an identifier of the recipient, where said communication is not recorded on the second distributed ledger;
(d) defining a plurality of secondary transactions, each comprising the recipient and a secondary originating party and an asset portion, wherein the combination of asset portions corresponds to the asset and at least some of which secondary originating parties indicate a party other than the originator;
(e) recording on the second distributed ledger the plurality of secondary transactions.
